(19) United States
(12) Patent Application Publication
(10) Pub. No.: US 2022/0162043 A1
(43) Pub. Date: May 26, 2022

(54) CABLE-DRIVEN ROBOTIC PLATFORM FOR LARGE WORKPLACE OPERATIONS

(71) Applicants: Amir KHAJEPOUR, Waterloo (CA); Hamed JAMSHIDIFAR, Waterloo (CA)

(72) Inventors: Amir KHAJEPOUR, Waterloo (CA); Hamed JAMSHIDIFAR, Waterloo (CA)

(21) Appl. No.: 17/600,751

(22) PCT Filed: Apr. 1, 2020
(86) PCT No.: PCT/CA2020/050427

§ 371 Date: Oct. 1, 2021

Related U.S. Application Data
(60) Provisional application No. 62/827,416, filed on Apr. 1, 2019.

(51) Int. Cl. B66C 13/22; B66C 21/00; B66C 13/42

(52) U.S. Cl. CPC B66C 13/22; B66C 2700/011; B66C 13/42; B66C 21/00

(57) ABSTRACT

The disclosure is directed at a robotic platform for use in large workspaces. The disclosure includes a moving platform that is controlled by a set of cable actuators via a set of cables. The cables are also connected to at least one of a counterbalancing and/or a counterweight system to reduce the impact of forces being experienced on the moving platform on the set of cable actuators. In one embodiment, at least two of the set of cable actuators are connected with a single closed cable loop.

### CROSS-REFERENCE TO OTHER APPLICATIONS

The current application claims priority from U.S. Provisional Application No. 62/827,416 filed Apr. 1, 2019, which is hereby incorporated by reference.

### FIELD

The current disclosure is generally directed at large workspace operations, and more specifically, at a cable-driven robotic platform for large workspace operations.

### BACKGROUND

In the field of construction, multi-level buildings are built with the assistance of cranes and the like. Cranes are typically used for materials handling while manual operations are necessary for almost all aspects of building construction typically resulting in a shortage of skilled workers and higher overall construction costs. Automation and robotics can significantly help in addressing the needs for skilled workers and reduce construction costs. The use of robotics and automation, especially in the construction of multi-level and/or high rise buildings is not straightforward due to the size of each floor, a cluttered work environment, obstructions and requirements for robots installation. Another problem is the difficulty in moving the robots/equipment from one floor to another. As a result, new concepts are needed to address the use of automation/robotics in building construction.

Currently, there are none or few robotic solutions for working in a very large workspace and with large payloads. Examples of large workspaces may include, but are not limited to, construction, open warehousing, agriculture, horticulture, and water treatment plants. In addition, mobility and reconfigurability in applications such as construction within different workspaces are very desirable.

Therefore, there is provided a novel cable-driven robotic platform for large workspace operations.

### SUMMARY

The disclosure is directed method and system for a cable-driven robotic platform for use in large workspace operations. In one embodiment, the platform may move in three dimensions (X, Y, Z) over the large workspace such as providing a space for holding all automation equipment and materials to perform a variety of operations in different applications. In one embodiment, the system includes cables instead of rigid elements, a special constrained cable management system for increasing rigidity and stability of the platform and a multi-dimensional counterbalancing or counterweight mechanism to reduce or eliminate the impact of forces acting on the platform and its equipment mass on the cable management system, such as the motor drive system.

By combining a passive constrained cable arrangement and active cable tension control, the stiffness of the platform may be controlled as it moves around the workspace. In one embodiment, the system includes an active vibration control system and/or a multi-axis reaction system to reduce, remove or eliminate any disturbances for making the platform stable during motion or operation or when stationary while the equipment on the platform performs an operation or interacts with the workspace environment.

In one embodiment, the system includes a multi-dimensional counterbalancing mechanism to reduce or eliminate the impact of the mass of the platform and the mass of the payload on the platform with respect to the robot motor drive system. In another embodiment, the system includes a counterweight system to reduce the effect of gravity or other forces on the platform.

In another embodiment, the system is configurable for use within different sized workspaces and at different heights within the workspaces.

Turning to an aspect of the disclosure, there is provided a robotic platform system for use in large workspace including a moving platform; a set of cable driving routing units (CDRU), each CDRU including a motor; and a set of cables connecting the moving platform to each of the CDRU; and at least one of a counterbalancing or counterweight system to reduce a size of the motor in each of the set of CDRU.

In another aspect, the counterbalancing system includes a guiding rail connected at each end to one of the set of CDRU; a floating slider for sliding back and forth along the guiding rail; a guide rail floating pulley attached to the floating slider; a set of counterbalancing floating pulleys; a counterbalancing weight connected to the set of counterbalancing floating pulleys; and a closed cable loop connected to the moving platform, the guide rail floating pulley and the set of counterbalancing floating pulleys. In In a further aspect, the floating slider slides along the guiding rail in concert with movement of the moving platform. In another aspect, a weight of the counterbalancing weight is associated with a weight of the moving platform.

In yet another aspect, the counterweight system includes a set of counterweight floating pulleys; a counterweight connected to the set of counterweight floating pulleys; and a closed cable loop connected to corners of the moving platform and passing through at least two of the set of CDRU and the set of counterweight floating pulleys. In a further aspect, the robotic platform system includes the counterbalancing system and the counterweight system. In another aspect, the counterbalancing system and the counterweight system are integrated together.

In a further aspect, the robotic platform system further includes a calibration system for calibrating a location of each of the set of CDRU. In yet another aspect, the robotic platform system further includes a set of height-adjustable towers; wherein each of the CDRU are mounted to one of the set of height-adjustable towers. In yet another aspect, one CDRU is mounted to one of the set of height-adjustable towers. In an aspect, each of the CDRU includes an upper actuator system; and a bottom actuator system.

In another aspect, the upper actuator system includes a traction wheel for receiving one of the set of cables; and the motor for controlling the traction wheel to retract and extend the one of the set of cables. In yet another aspect, the robotic platform system further includes a central processing unit (CPU) for controlling each of the set of CDRU. In an aspect, the robotic platform system of further includes a linear/non-linear counterbalancing system. In another aspect, the linear/non-linear counterbalancing system includes a closed cable loop mounted to a set of pulleys and attached to the counterbalancing weight. In another aspect, the closed cable loop include two different density cable segments.

In another aspect of the disclosure, there is provided a system for a robotic platform for use in large workspaces including a moving platform; a set of cable controlling units; a set of cables connected between the moving platform and the set of cable controlling units; and at least one counterbalancing or counterweight system for managing unwanted forces being experienced by the moving platform, the at least one counterbalancing or counterweight system attached to the moving platform and integrated with at least some of the set of cables.

In an aspect, the at least one counterbalancing or counterweight system is a counterbalancing system. In a further aspect, the counterbalancing system includes a guide connected to the moving platform; a set of pulleys; a counterbalancing apparatus; and a closed cable loop passing through the set of pulleys and the guide and connected to the counterbalancing apparatus; wherein the counterbalancing apparatus provides a counterforce to gravity acting on the moving platform. In yet another aspect, the counterbalancing apparatus includes at least one of a counterbalancing weight, an air spring, a normal spring or a constant spring. In a further aspect, the counterbalancing system further includes a guide rail; and a moving pulley that slides up and down the guide rail wherein the moving pulley is one of the set of pulleys; wherein movement of the moving pulley with respect to the moving platform provides a counterbalancing force to the moving platform. In another aspect, the counterbalancing apparatus includes an air spring. In an aspect, the counterbalancing apparatus further includes a hydraulic cylinder and an accumulator.

In a further aspect, the at least one counterbalancing or counterweight system is a counterweight system. In another aspect, the counterweight system includes a counterweight apparatus; and a closed cable loop passing through two adjacent cable controlling units and the counterweight apparatus and connected to two corners of the moving platform. In yet another aspect, the counterweight apparatus includes a set of pulleys; and a counterweight; wherein at least some of the set of pulleys receive the closed cable loop and are indirectly connected to the counterweight. In an aspect, the counterweight is a cable having at least two different density segments.

In another aspect, the system includes a controller for controlling the cable controlling units and the at least one counterbalancing or counterweight system. In yet another aspect, the system further includes a set of towers defining the large workspace, the set of towers for housing one of the set of cable controlling units. In an aspect, the number of towers in the set of towers equals the number of cable controlling units in the set of cable controlling units.

In yet a further aspect, each of the set of cable controlling units includes a top actuator unit. In another aspect, each of the set of cable controlling units includes a bottom actuator unit.

### DESCRIPTION OF THE DRAWINGS

Further features and exemplary advantages will become apparent from the following detailed description, taken in conjunction with the appended drawings, in which:

FIG. 1a is a schematic diagram of a robotic platform system for use in a large workspace;

FIG. 1b is a schematic diagram of a second embodiment of a robotic platform system for use in a large workspace;

FIG. 2 is a schematic view of different heights for a tower/stand for use in the robotic platform system of FIG. 1a;

FIG. 3 is a schematic perspective view of the robotic platform used in a construction application;

FIG. 4 is a schematic side view of the robotic platform used in a construction application;

FIG. 5 is a schematic diagram of a conventional cable actuation system;

FIG. 6 is a schematic diagram of a conventional constrained cable actuation system in 2D;

FIG. 7 is a schematic diagram of a conventional constrained cable actuation system in 3D;

FIG. 8a is a schematic diagram of a cable actuation system in accordance with the system of the disclosure in 2D

FIG. 8b is a schematic diagram of components of the cable actuation system;

FIG. 8c is a schematic diagram of cable path within the cable actuation system;

FIG. 9 is a schematic diagram of a cable actuation system in accordance with the system of the disclosure in 3D;

FIG. 10 is a schematic diagram of another embodiment of a cable actuation system in accordance with the system of the disclosure;

FIG. 11 is a schematic diagram of a conventional wheel traction angle;

FIG. 12 is a schematic diagram of a traction wheel contact angle in accordance with the system of the disclosure;

FIG. 13 is a schematic diagram of counterweights in an elevator system;

FIG. 14 is a schematic diagram of a counterbalancing mechanism for use in the robotic platform;

FIG. 15 is a schematic diagram of an embodiment of a conventional counterweight mechanism;

FIG. 16 is a schematic diagram of a counterweight system in accordance with an embodiment of the disclosure;

FIG. 17 is a schematic diagram of a combined counterbalancing mechanism and a counterweight system as separate systems;

FIG. 18 is a schematic diagram of a combined counterbalancing mechanism and a counterweight system as a single system;

FIG. 19 is a schematic diagram of a combined counterbalancing mechanism and a counterweight system with constrained actuation;

FIG. 20 is a schematic diagram of cable motion for the system of FIG. 19;

FIG. 21 is a 3D view of FIG. 20;

FIG. 22a is a schematic diagram of an embodiment of a linear counterweight system;

FIG. 22b is a schematic diagram of a cable path through the counterweight system;

FIG. 23 is a schematic diagram of the components of the system of FIG. 22;

FIG. 24 is a set of schematic views of a portion of the counterweight system of FIG. 22;

FIG. 25 is a set of schematic views of the counterweight load of the embodiments of FIG. 24;

FIG. 26 is a schematic diagram of an embodiment of a non-linear counterweight system;

FIG. 27 is a schematic diagram of a conventional constrained cable actuation system;

FIG. 28 is a schematic diagram of a constrained cable robot with a counterbalancing and counter weight system;

FIG. 29 is a schematic diagram of the workspace of the cable robot of FIG. 27 with an allowable cable tension of 3 kN;

FIG. 30 is a schematic diagram of the workspace of the cable robot of FIG. 27 with an allowable cable tension of 6 kN;

FIG. 31 is a schematic diagram of the workspace of the cable robot of FIG. 28 with an allowable cable tension of 3 kN;

FIG. 32 is a schematic diagram of another embodiment of the disclosure with a planar cable robot with linear counterweight systems;

FIG. 33 is a schematic diagram of another embodiment of the disclosure with a planar cable robot with linear counterweight systems;

FIG. 34 is a schematic diagram of the counterbalancing system mounted to a 3D cable driven robot;

FIG. 35 is a schematic diagram showing an application of the counterbalancing system of FIG. 34;

FIG. 36 is a simplified version of FIG. 35;

FIG. 37 is a schematic diagram of another embodiment of a counterbalancing system for a 3D robotic platform;

FIG. 38 is a schematic diagram of yet another embodiment of a counterbalancing system for a 3D robotic platform;

FIG. 39 is a schematic diagram of the embodiment of FIG. 38 with constrained cables;

FIG. 40 is a schematic diagram of another counterbalancing system embodiment of a 3D robotic platform;

FIG. 41 is a schematic diagram of another counterbalancing system embodiment of a 3D robotic platform;

FIG. 42 is a schematic diagram of another counterbalancing system embodiment of a 3D robotic platform;

FIG. 43 is a schematic diagram of another counterbalancing system embodiment of a 3D robotic platform;

FIG. 44 is a schematic diagram of another counterbalancing system embodiment of a 3D robotic platform;

FIG. 45 is a schematic diagram of cable tension for the system of FIG. 44;

FIG. 46 is a schematic diagram of a robotic platform with a co-ordinate system;

FIG. 47 is a diagram showing planes;

FIG. 48 is a schematic diagram of a robotic platform with towers at different heights;

FIG. 49 is a schematic diagram of a robotic platform with towers at different positions;

FIG. 50 is a schematic diagram of a moving platform;

FIG. 51 is a schematic diagram of a calibration system for use with the robotic platform;

FIG. 52 is a schematic diagram of inverse kinematic corresponding vectors;

FIG. 53 is a flowchart outlining a method of calibration;

FIG. 54a is a schematic diagram of another embodiment of a robotic platform system for use in a large workspace;

FIG. 54b is a schematic diagram of another embodiment of a robotic platform system for use in a large workspace;

FIG. 54c is a schematic diagram of another embodiment of a robotic platform system for use in a large workspace;

FIG. 55 is a schematic diagram of another embodiment of a robotic platform system for use in a large workspace;

FIG. 56 is a schematic diagram of another embodiment of a robotic platform system for use in a large workspace;

FIG. 57 is a schematic diagram of another embodiment of a robotic platform system for use in a large workspace; and

FIG. 58 is a schematic diagram of another embodiment of a robotic platform system for use in a large workspace.

### DETAILED DESCRIPTION OF THE EMBODIMENTS

The disclosure is directed at a method, apparatus and system for a cable-driven robotic platform for large workspace operations. In one embodiment, the system includes a platform that is connected, via cables, to a set of cable drive and routing units (CDRU). The CDRUs are typically mounted to towers that surround the platform and/or the large workspace. Examples of large workspaces may include, but are not limited to, construction, open warehousing, agriculture, horticulture, and water treatment plants.

The system of the disclosure provides an adaptive robotic system for use in a workspace where a height of a robotic platform and positions of towers may be reconfigured. The system of the disclosure may also include a constrained cable configuration whereby the large workspace robotic platform has three (3) degrees of freedom (DOFs). In another embodiment of the system of the disclosure, there is provided a multi-dimensional counterbalancing, and/or counterweight system to reduce or eliminate the impact of the mass of the moving robotic platform and other equipment/machines installed on the platform. An advantage of this is to reduce a cost and size of the drive system whereby the disclosure may be used in much wider applications that require higher payload capacity. The disclosure is also directed at a novel calibration system.

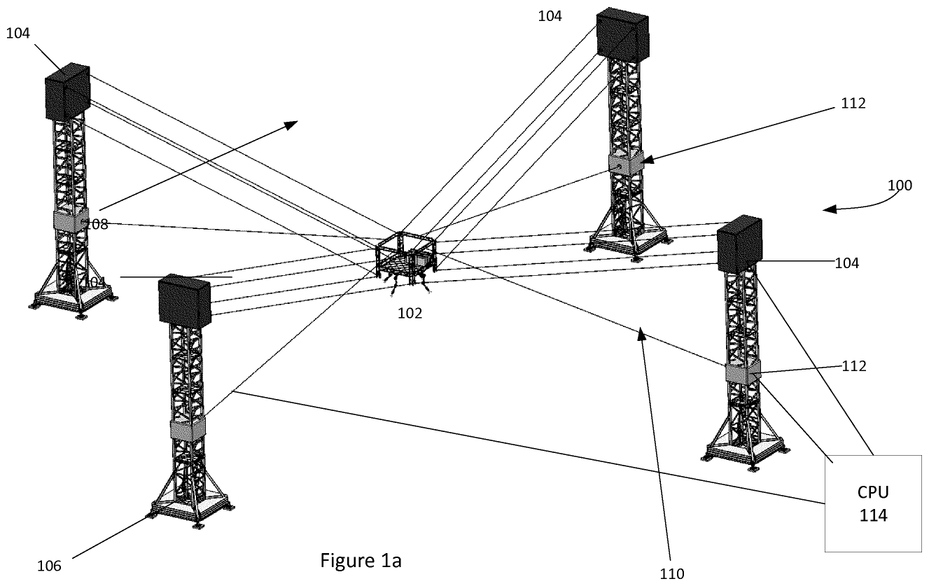

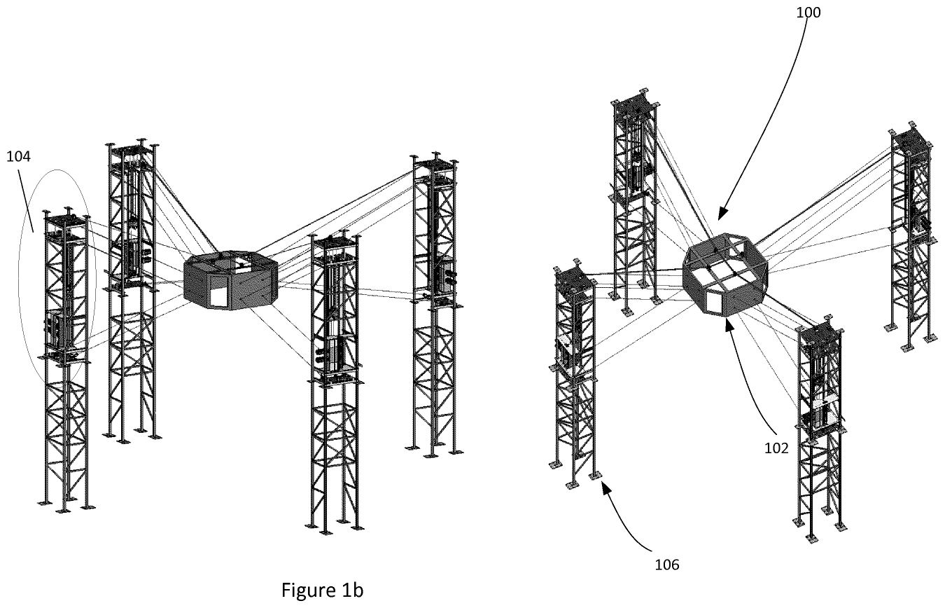

Turning to FIG. 1a, a schematic diagram of a first embodiment of a system for a robotic platform for a large workspace operation is shown.

The system 100 includes a moving, or moving robotic, platform 102 that is controlled by a set of CDRU, or top actuators, 104 where each CDRU 104 is installed on a tower or portable stand 106 located around the large workspace. In the current embodiment, there are four (4) CDRU 104 and four (4) portable stands 106. The towers are preferably positioned to define the corners, or edges, of the large workspace. In the current embodiment, each CDRU 104 has multiple identical-length cables 108 which are pulled, or controlled, by an individual actuator (not shown) within each CDRU 104. In the current figure, these may be seen as top, or upper, cables. In order to maintain the tension for each of the cables 108, the system 100 may further include a set of bottom, cables 110, actuated by four individual bottom actuators 112, that are used to pull the moving platform 102 downward. The bottom actuators 112 for the bottom cables 110 are preferably mounted, or integrated, within the portable stand 106 at a location beneath the CDRU 104 or top actuator. The system may further include a central processing unit (CPU) 114 to control the CDRU 104 and to determine parameters for force being experienced by the platform. The CPU 114 may also receive signals or readings from sensors throughout the system to determine the operation of the CDRU 104. Depending on a footprint of the large workspace, these stands 106 can be placed in different locations within the large workspace. In a preferred embodiment, the locations of the towers are placed in the corners of a rectangular workspace but it is understood that the towers may be located in any position, preferably on the edge of the large workspace.

Turning to FIG. 1b, another embodiment of a system for a robotic platform is shown. In the current embodiment, both the top actuator and the bottom actuator may be seen as a single CDRU whereby in the current embodiment, each portable stand 106 is associated with a single CDRU 104.

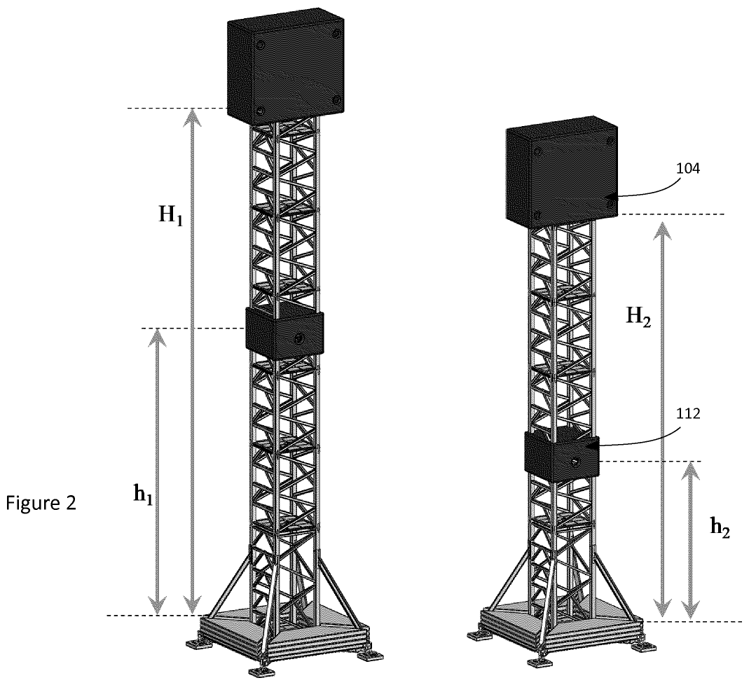

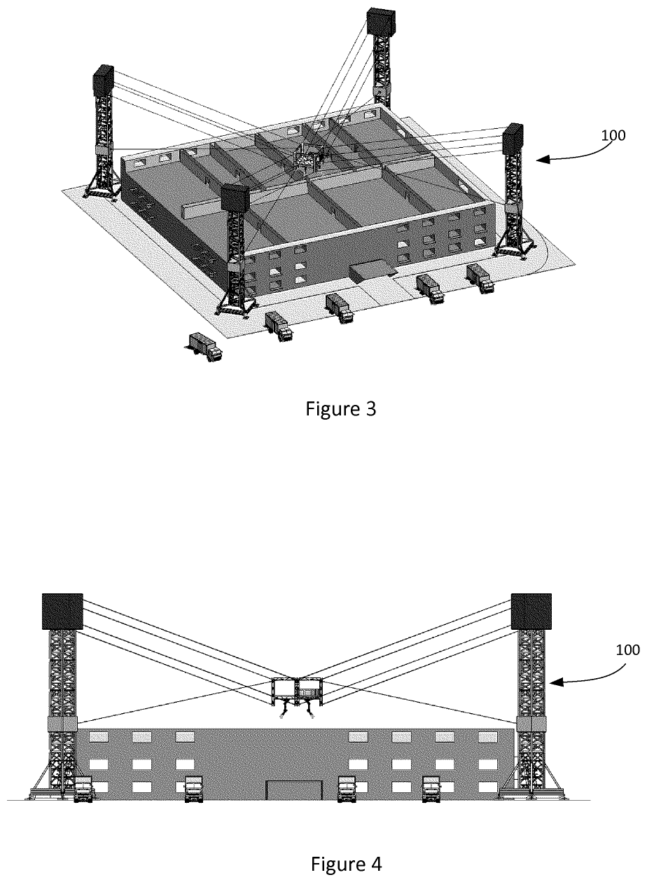

As shown in FIG. 2, a height of the CDRU, or top actuator, 104 with respect to ground is denoted as H and a height of the bottom actuator 112 with respect to ground is denoted by h. FIG. 2 shows the portable stand 106 at two different heights, H₁/h₁ and H₂/h₂. Both heights, H and h, may be adjusted, or reconfigured, as discussed below. In a preferred embodiment, H and h are selected in order to optimize, or define, a size and shape of the large workspace with respect to a required load capacity (with respect to the moving platform 102). The height configuration allows the system of the disclosure to adapt to the characteristics of the large workspace such that the system is capable of use in various workspaces with different shapes and heights. The different heights may also be used to determine how to counterbalance the moving platform when in use. As an example, the system may be used in the construction of large buildings such as schematically illustrated in FIG. 3 whereby height reconfiguration of the portable stands 106 allows the moving platform to cover the large workspace at different heights, such as for different floors of the building, as schematically illustrated in FIG. 4. As shown in FIG. 2, when the top actuator is at height H₂ and the bottom actuator is at height h₂, the system may be used to build the 2^{nd} floor of the building and when the top actuator is at height H₁ and the bottom actuator is at height h₁, the system may be used to assist in building the 3rd floor of the building.

In a preferred embodiment of the system, each of the CDRU 104 includes a constrained cable apparatus, or configuration, in order to provide three (3) degrees of freedom (DOFs) to the moving platform. For ease of understanding the cable configurations, the following description is described in two-dimensional (2D) use and then extended to a description of three-dimensional (3D) use.

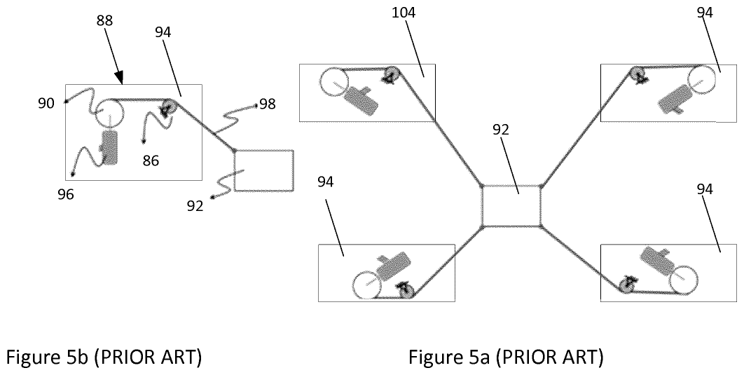

Turning to FIGS. 5a and 5b, schematic diagrams of a conventional robotic system (for small workspaces) is shown. The system includes a platform 92 connected via a set of cables 98 to individual CDRUs 94. FIG. 5b is a schematic view of a single CDRU 94 connected to the platform 92.

In this prior art CDRU 92, the CDRU 92 includes an actuation apparatus 88 that includes a guiding pulley 86 that guides the cable 98 (from the platform 92) to a collecting winch 90 that is controlled by a motor 96. Therefore, when necessary, or when signalled, the motor 96 actuates to rotate the winch 90 to either draw the platform 92 toward (counter-clockwise) or to allow the platform 92 to move away from (clockwise) the CDRU 94 by controlling a length of the cable 98.

In this embodiment of platform actuation, each cable 98 is pulled by its associated individual winch 90 such as illustrated in FIG. 5a which shows four cables being used to move the platform 92 in a single vertical plane.

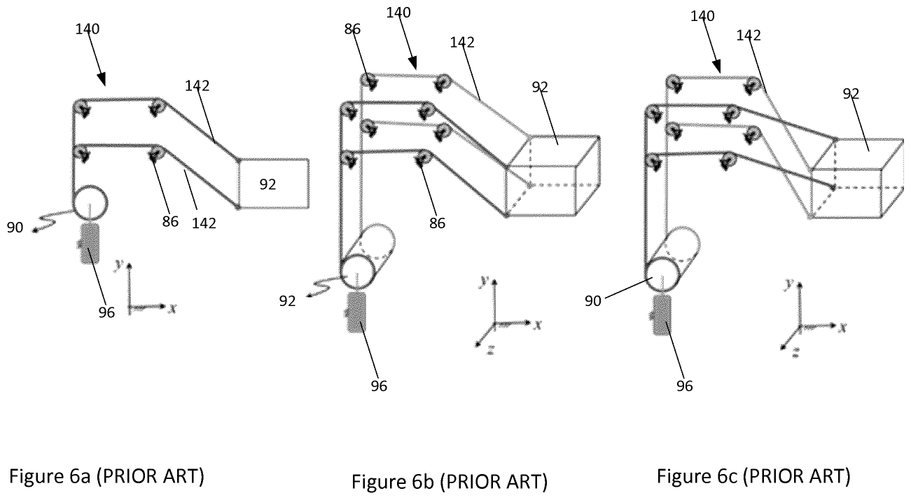

With respect to translational motion for the moving platform 92, the actuation apparatus may be replaced by a constrained actuation apparatus 140 that includes a set of constrained actuation of cables. Examples, or embodiments, of a constrained actuation apparatus 140 are schematically shown in FIGS. 6a to 6c.

As shown in FIGS. 6a to 6c, different embodiments of a constrained actuation apparatus are shown. In each embodiment, multiple cables 142, having identical lengths, are actuated by a single actuator 144. In each of the embodiments, the cables 142 pass through a set of pulleys 86 before being connected to the collecting winch 90 controlled by the single motor or actuator 96.

In FIG. 6a (which is a 2D view), the cables 142 are connected to a pair of corners of the platform 92 and then connected to the single actuator 96 that controls both cables 142. In FIG. 6b (which is a 3D view), a first and second pair of cables 142 are connected to different pairs of adjacent corners of the platform 92 and both pairs of cables 142 are connected to the single actuator 96. In FIG. 6c, a similar set-up to FIG. 6b is shown with the cables crossing each other. While the embodiments of FIGS. 6a to 6c only show a single CDRU 94 connected to the platform 92, it is understood that an overall system will have more CDRUs.

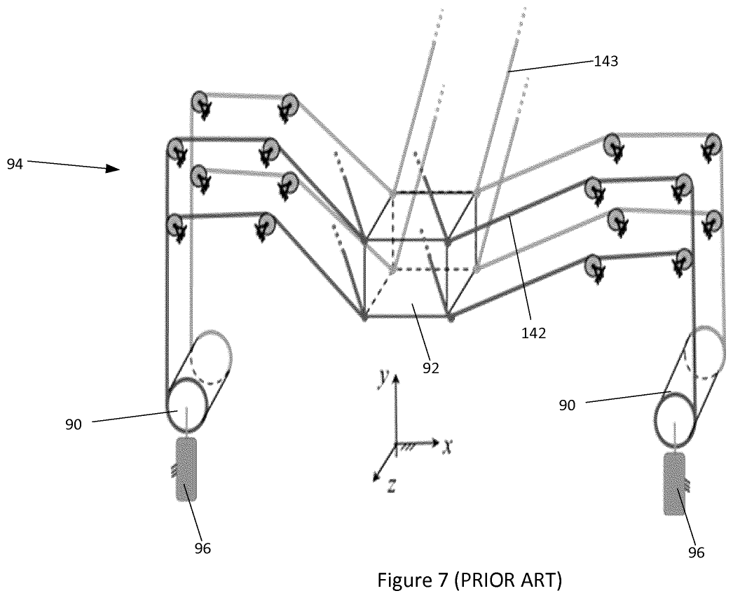

FIG. 7 provides a further view of a prior art constrained cable apparatus for a robotic platform. In FIG. 7, two sides are shown connected to CDRUs 94 while only cables 143 are shown for the other two sides. Constrained actuation of the cables 142 or 143, as illustrated in FIG. 7, may be used for 3D cable robots as well. In such an arrangement of the cables, the moving platform's rotation around all axes is limited where the stiffness of the robotic platform is improved.

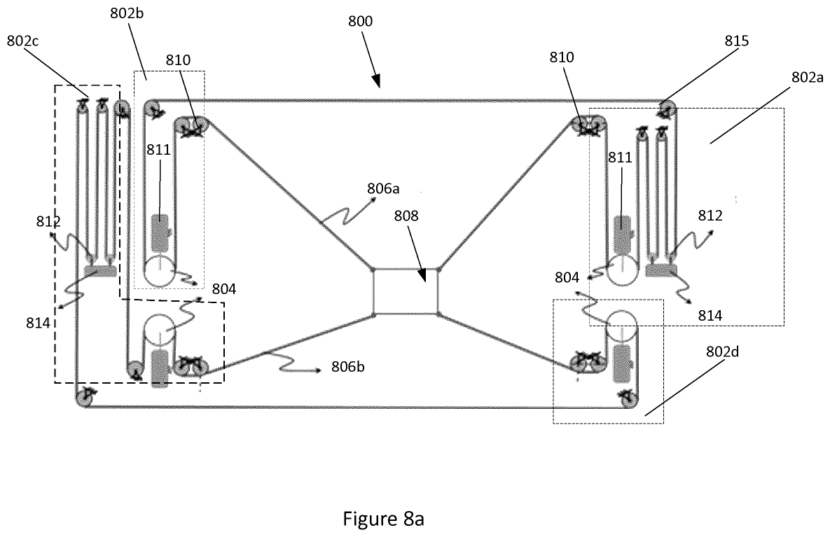

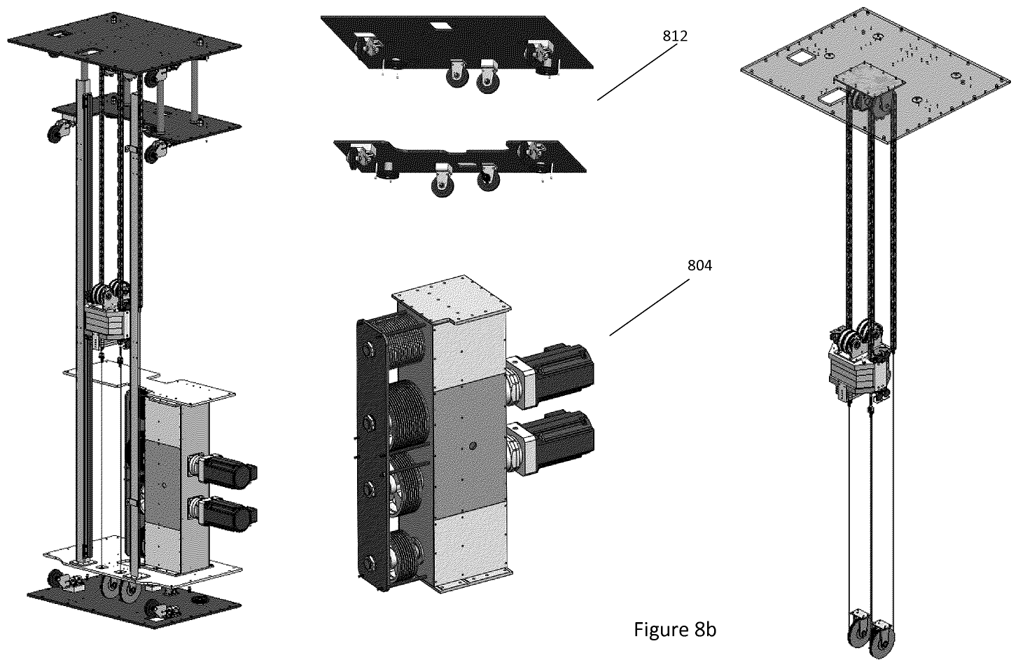

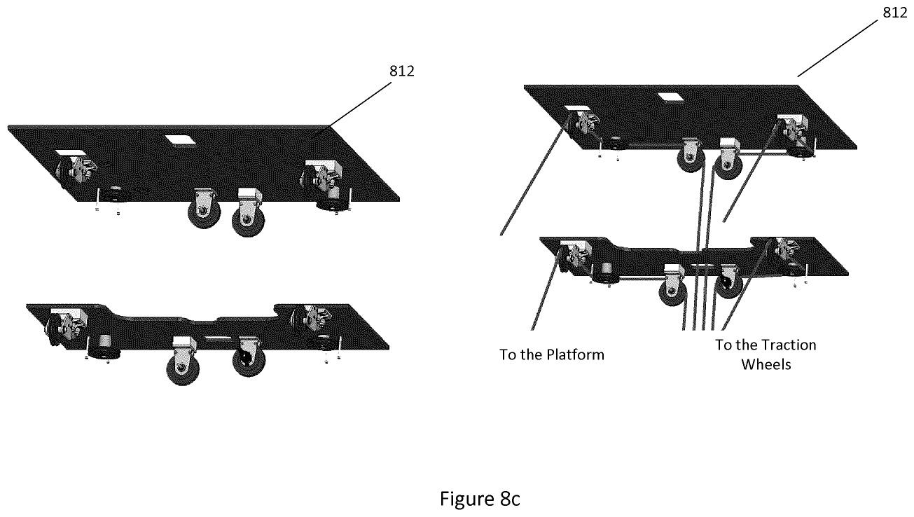

Turning to FIG. 8a, an embodiment of an actuation system with respect to the disclosure is shown. In the embodiment of FIG. 8a, which is in 2D, the system 800 only shows four CDRU 802 for ease or explanation but it will be understood that further CDRUs may be added to implement the system for a robotic platform. For planar motion, four (4) CDRU are typically used. Each CDRU 802 includes one traction wheel 804 for actuation of the cables 806. As can be seen, instead of requiring an individual set of cables for each CDRU (as in the prior art), the system of the disclosure reduces the number of sets of cables by using cable loops that connect at least two different CDRU 802 to the moving platform 808.

As shown in FIG. 8a, two cables 806 (seen as cable loops) and four traction wheels 804 are used to move the platform 808 in a single plane. In a first cable loop 806a, the cable loop is connected to a corner of the platform 808 and passes through a first CDRU 802a. Within the first CDRU 802a, the cable loop 806 passes over a set of pulleys 810 and through the traction wheel 804 (which is controlled by a motor 811). The cable 806a is then passed through a set of floating pulleys 812. In one embodiment, the floating pulleys are idler pulleys.

A vertically floating mass 814 is connected to some of the floating pulleys 812 in order to maintain a tension of the cables for the cable loop 806a. This may be seen as a counterweight, or a counterweight balancing, system. The cable loop 806a is then passed through further pulleys 815 and through a second CDRU 802b before being connected to another corner of the platform 808. Within the second CDRU 802b, the cable loop 806a passes a set of land-fixed pulleys 810 and a traction wheel 804 controlled by a motor 811. The second cable loop 806b is similarly connected through a CDRU 802c (similar to the first CDRU 802a) and a CDRU 802d (similar to the second CDRU 802b).

FIG. 8b are schematic diagrams of the components of the CDRU including the pulley system 810, the traction wheel 804 and the counterweight system. FIG. 8c is a schematic diagram of a cable path with respect to the traction wheel 804 with the arrows showing cable path direction.

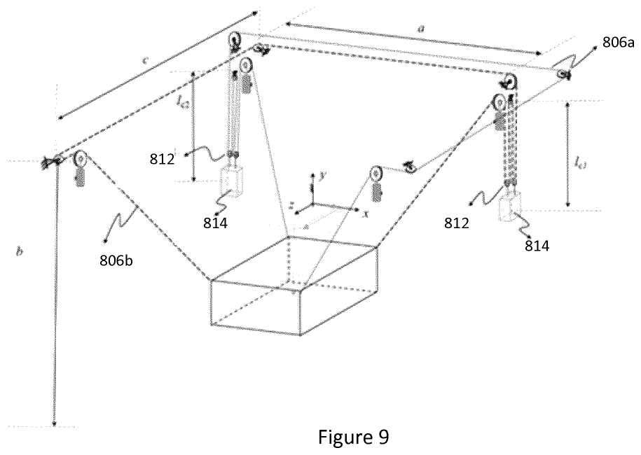

One embodiment of a system or application of traction wheels for 3D cable-robots is shown in FIG. 9, where two cable loops and four actuators are used to manipulate the platform.

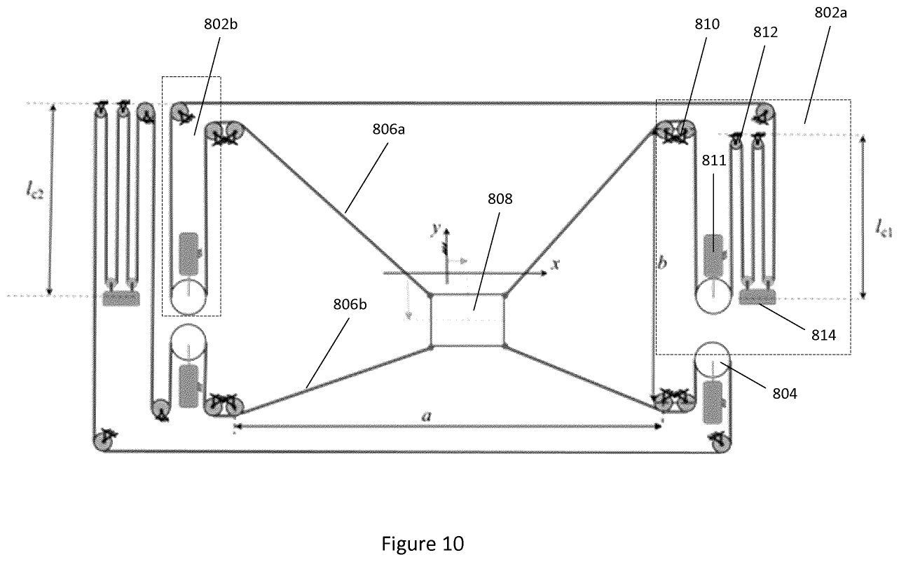

In the example of FIG. 9, as schematically shown in FIG. 10, moving the platform to different points of the plane (different x and y coordinates), changes the height position of the floating masses 814 which can be larger than the height of workspace. The corresponding variable to such heights are denoted by I_{c1} and I_{c2} in FIG. 10, where the large workspace dimensions are denoted by a and b.

Based on geometrical calculation, the maximum, or highest, variation of I_{c1} and I_{c2} in such system is

$$\frac{( \sqrt{4 {b}^{2} + {a}^{2}} ) - ( \sqrt{{b}^{2} + {a}^{2}} )}{n}$$

where n denotes the number of floating pulleys 812 connected to the floating mass 814 of each cable loop 806a or 806b. Accordingly, by increasing the number of floating pulleys 812 (n), the height variation of the floating mass 814 can be reduced to fit the height of workspace.

Also, in order to correct for the slippage of the cables on the traction wheel 804, denoting the contact angle of the cable with the traction wheel by α and the friction coefficient of such contact by μ, the ratio of tensions on each traction wheel is

$$\frac{{T}_{1}}{{T}_{2}} = {e}^{μ α} .$$

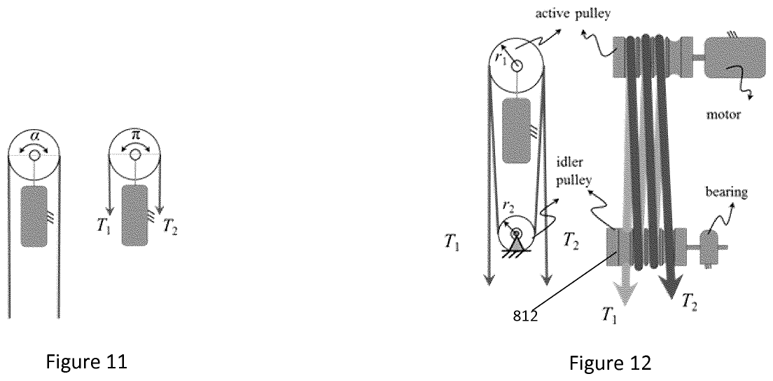

As illustrated in FIG. 11, in the case of having α=π and the friction coefficient of steel-to-steel contact as μ=0.2, we have

$$\frac{{T}_{1}}{{T}_{2}} = 1.87$$

which in many cases may not be enough to prevent or reduce the cable slippage on the traction wheel 804. FIG. 11 may be seen as a schematic diagram of a wheel traction angle in a conventional approach.

In order to address this, a system for handling cable slippage is shown in FIG. 12. As shown, by using an idler pulley 812 with a smaller radius r₂<r₁, multiple round of cables 806 can be used to increase the contact angle α which based on the relation

$$\frac{{T}_{1}}{{T}_{2}} = {e}^{μ α} ,$$

can increase the tension ratio

$$\frac{{T}_{1}}{{T}_{2}}$$

exponentially.

In order to address the impact that the mass of the moving platform 808 and equipment that is loaded on the moving platform 808 may have on the drive system, the system may include a multi-dimensional counterbalancing system. This counterbalancing system may reduce the cost and size of the drive, or motor, system. This may also allow the system for a robotic platform to be used in much wider applications that require a higher payload capacity.

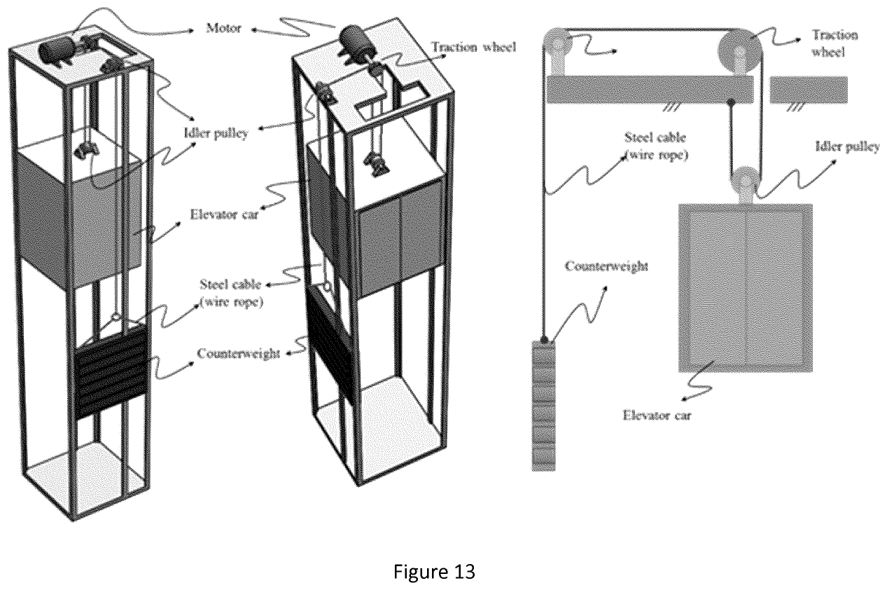

As above, the following description of the counterbalancing system is first taught in 2D and then extended to 3D. In order to counterbalance the weight of the moving platform 808, the counterbalancing system may operate similar to an elevator counterweight system as schematically shown in FIG. 13. As shown, a single loop of cable may cancel the whole or some part of the elevator's car weight.

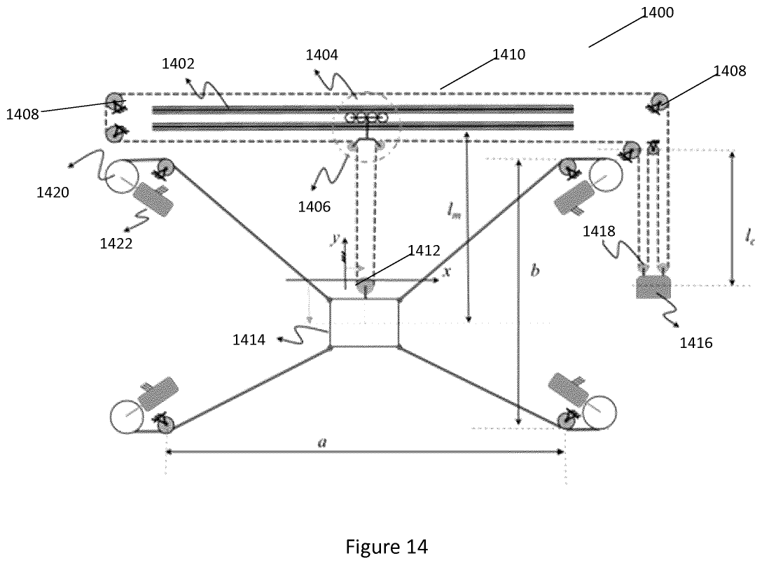

One embodiment of a counterbalancing system for use in an embodiment of the disclosure is shown in FIG. 14. In the current system, a single cable loop may be used to cancel the weight of the moving platform.

In the current embodiment, the counterbalancing system 1400 includes a guiding rail 1402 that includes a floating slider 1404 that rides along the guiding rail 1402. The guiding rail 1402 and floading slider 1404 may be seen as a moving trolley 1403. Ends of the guiding rail 1402 may be mounted to the portable stands 106 of the system or may be mounted to an independent support system. A floating pulley 1406 is mounted to the floating slider 1404. The counterbalancing system 1400 further includes a set of cable guides (or fixed pulleys) 1408 that receive a cable (seen as closed cable loop 1410). The closed cable loop 1410 passes through the floating pulley 1406 to a guide 1412 that is located on the moving platform 1414. A counterbalancing weight 1416 is mounted to the closed cable loop 1410 (via some of the pulleys 1408) to provide the necessary counterbalance as will be discussed below. The platform 1414 is further connected to a set of CDRU 1419 including a traction wheel 1420 and an actuator 1422. While only certain components of the CDRU 1419 are shown, it will be understood that these may be the same or similar to the arrangement or arrangements disclosed previously.

Using the floating roller, or slider 1404, which is free to move along the fixed guiding rail 1402, a constant vertical force is applied on the moving platform 1414 all over the large workspace. The vertically moving counterweight (being used as a counterbalance) 1416 enables a constant tension of the closed cable-loop 1410 to be adjusted. Accordingly, the weight of the moving platform 1414 along with any different mases that are loaded on to the platform can be cancelled by this counterbalancing mechanism which helps to reduce the torque needed by each actuator (or motor) 1422 in each CDRU 1419 to move the platform 1414 thereby reducing the size and characteristics of each actuator 1422 needed to move the platform 1414. In the current embodiment, the parameter of counterweight height variation is denoted by I_{c} where its maximum is

$$\frac{b}{n}$$

where n denotes the number of floating pulleys 1408 attached to the counterweight 1416. Accordingly, in a worst case, the highest or maximum value of I_{c} is b which is equal to the height of workspace where by increasing n, the vertical motion of the counterweight is smaller than the workspace height.

By adding the counterbalancing system of FIG. 14 to any planar cable-robot, the load on the motors in the CDRU or the top actuator can be reduced which helps to reduce the size of motors needed for the CDRU.

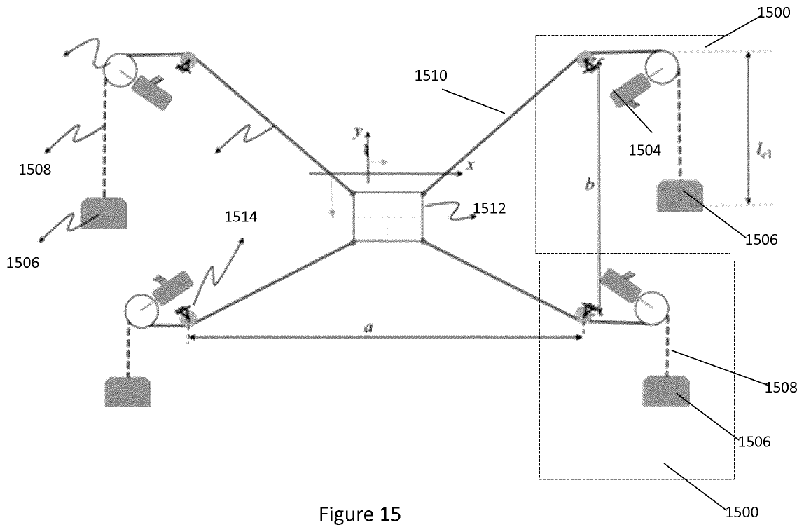

Current systems may also include a motor torque counterbalancing mechanism that is used for motor torque reduction. This torque reduction counterbalancing mechanism may cancel the effects of platform weight on the actuators. The torque reduction counterbalancing mechanism includes individual counterweights for the motors, as schematically illustrated in FIG. 15.

As shown in FIG. 15 (which is a side view of a robotic platform), each CDRU 1500 includes a cable collecting winch 1502 and a motor 1504 along with a counterweight 1506 that is connected via a counterweight cable 1508 to the cable collecting winch 1502. The cable collecting winch 1502 receives a cable 1510 that is connected to the moving platform 1512 with the motor 1504 controlling the movement of the cable (and the moving platform) with respect the CDRU 1500. The cable may further be passed through an idler pulley 1514.

A distance between idler pulleys connected to two adjacent bottom corners of the moving platform 1512 may be seen as “a” while a distance between a bottom platform CDRU, or bottom actuator, and a top actuator may be seen as “b”. An X-Y axis is also provided in FIG. 15 with X representing horizontal movement and Y representing vertical movement with respect to ground.

For each CDRU 1500, each motor 1504 or cable controlling winch 1502 is supported by the counterweight 1506 that is used to apply a reverse torque on the winch 1502 to balance some part of the actuation torque required to provide the cable tension for cable 1510. With current systems, the main problem is that the motion of counterweight can be larger than the height of workspace. For example, the highest or maximum value of I_{c1} in FIG. 15, can be \sqrt{b²+a²} which is larger than the workspace height b.

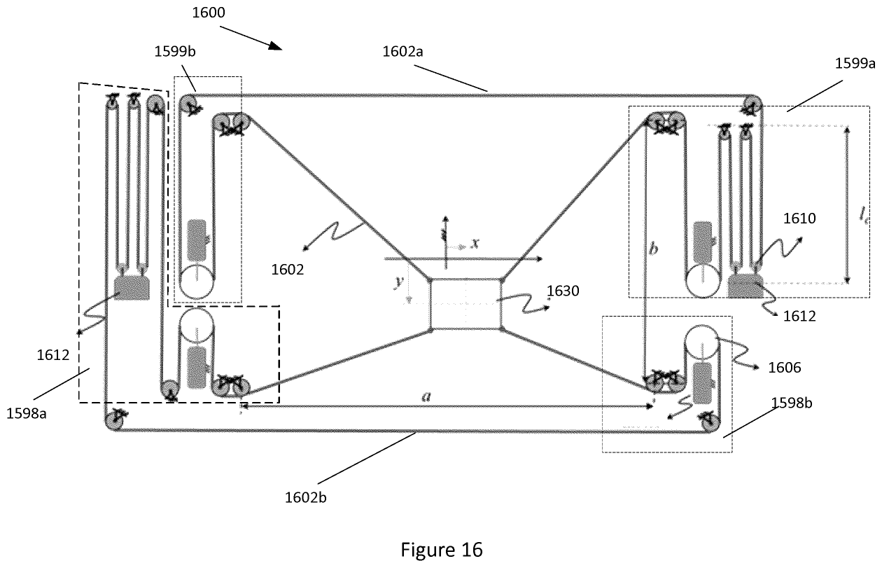

Accordingly, in order to address such problem, instead of individual counterweights for each CDRU (as shown in FIG. 15), common counterweights are used in the counterweight system shown in FIG. 16 which is a side view of an embodiment of a system for a robotic platform of the disclosure.

Turning to FIG. 16, the system 1600 includes two closed cable loops 1602a and 1602b. Each of the closed cable loops has its two ends connected to two adjacent corners of a platform 1630. Cable loop 1602a is used to connect two adjacent top actuators 1599a and 1599b while cable loop 1602b is used to connected two adjacent bottom actuators 1598a and 1598b. With the top two corners (with respect to FIG. 16), the cable 1602a is connected to a first corner and then passes through a set of idler pulleys 1604 and a traction wheel 1606 and then through another set of idler pulleys 1608 in one of the CDRU 1599b. The cable is then passed to the second CDRU 1599a, through a set of floating pulleys 1610 with a common counterweight 1612 connected to some of the floating pulleys 1610. The cable 1602a is then passed through another traction wheel 1606 and a further set of idler pulleys 1604 (associated with the second CDRU 1599a) and connected to another corner of the moving platform. A similar cable structure is provided for the bottom corners between cable loop 1602 and bottom actuators 1598a and 1598b. The distances “a” and “b” are the same as shown above with respect to FIG. 15.

The common counterweight 1612 keeps the cable loop 1602a under tension and also helps to reduce the load on the motors. By increasing the number of floating pulleys, I_{c} can be shorter than b.

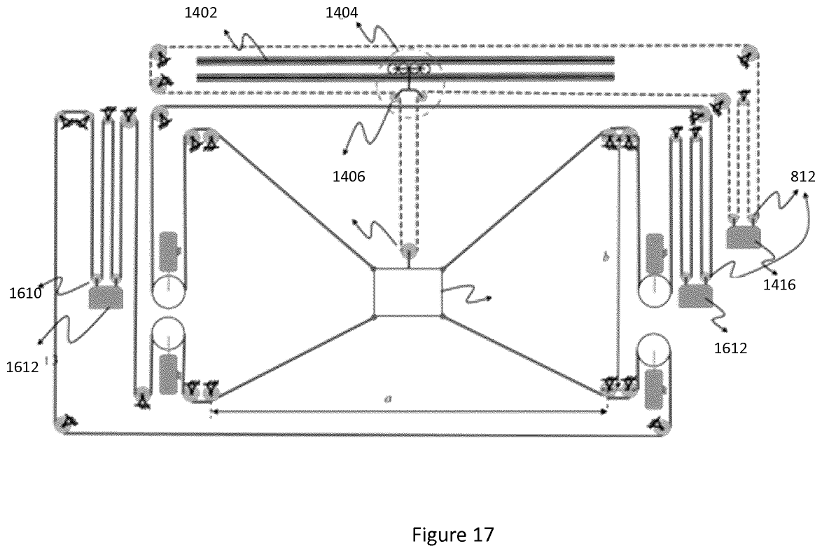

In a preferred embodiment, the system of the disclosure may include both the counterbalancing system of FIG. 14 and the counterweight system of FIG. 16, although, it will be understood that some embodiments may only include one of these systems. One embodiment of a system of the disclosure is schematically shown in FIG. 17. In the embodiment of FIG. 17, the counterbalancing system and the counterweight system are independent from each other.

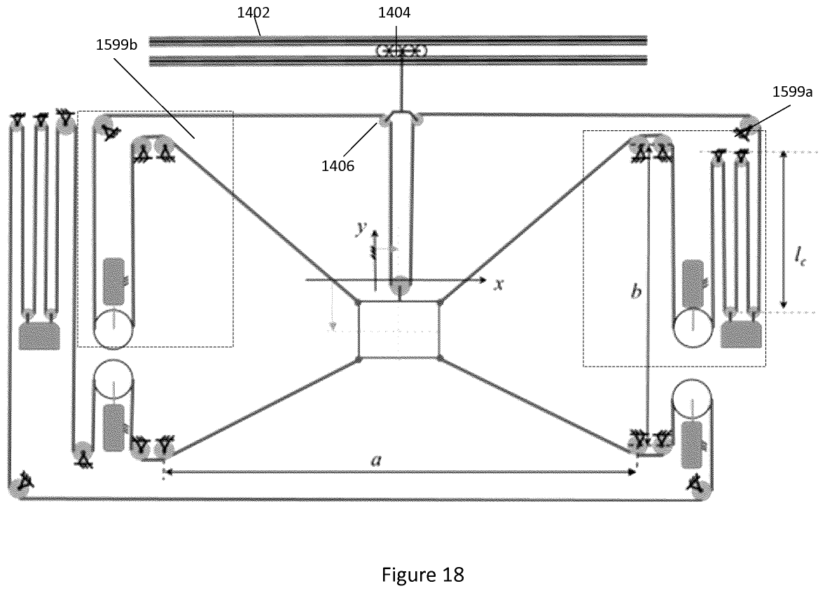

In a further embodiment, the counterbalancing and the counterweight systems may be combined in a single cable-loop system. This is schematically shown in FIG. 18.

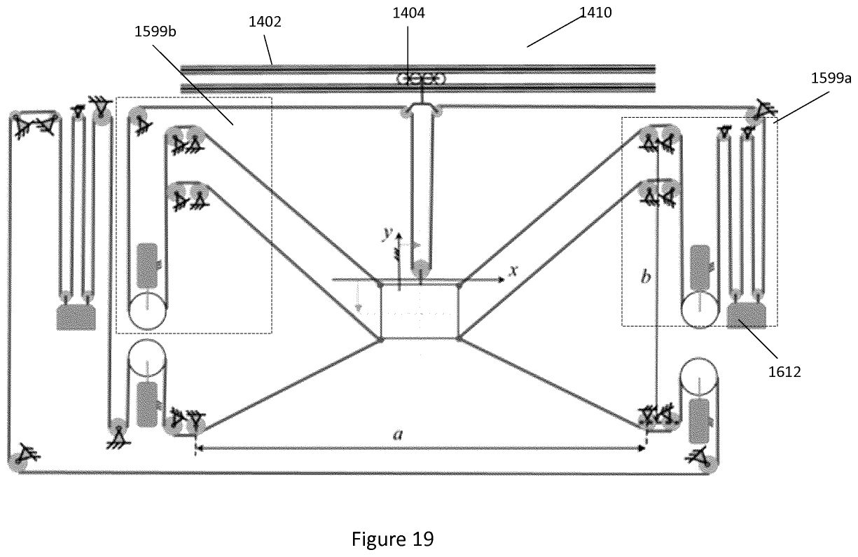

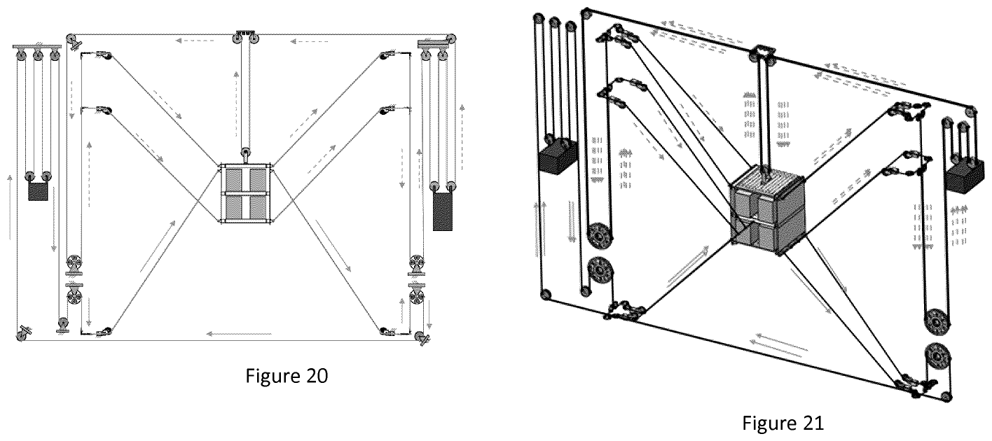

In the current embodiment, a high or maximum value of I_{c} may be seen as

$$\frac{( b + \sqrt{4 {b}^{2} + {a}^{2}} ) - ( \sqrt{{b}^{2} + {a}^{2}} )}{n}$$

whereby selecting proper values for the number of floating pulleys (n) can result in I_{c} being smaller than the workspace height b. As can be seen in FIG. 18, a single weight is used for both the counterbalancing and the counterweight. As will be understood, the system of FIG. 18 may also be used to constrained cable robots as well such as schematically shown in FIG. 19. FIGS. 20 and 21 are directed at the system of FIG. 18 showing a direction of motion of the cable loops in 2D (FIG. 20) and 3D (FIG. 21).

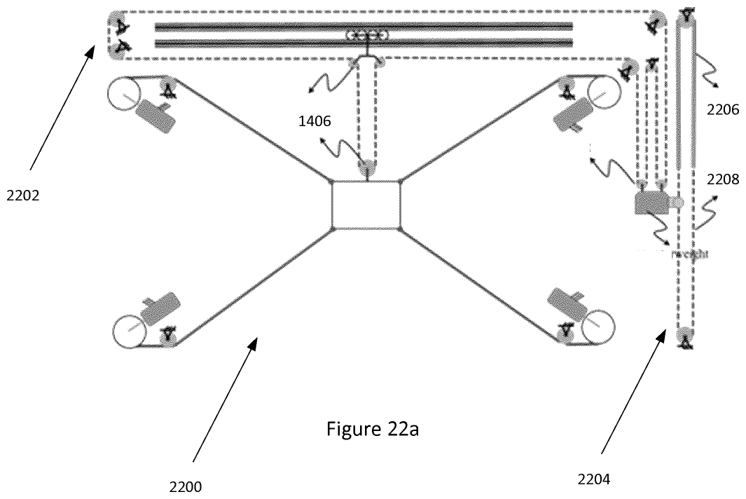

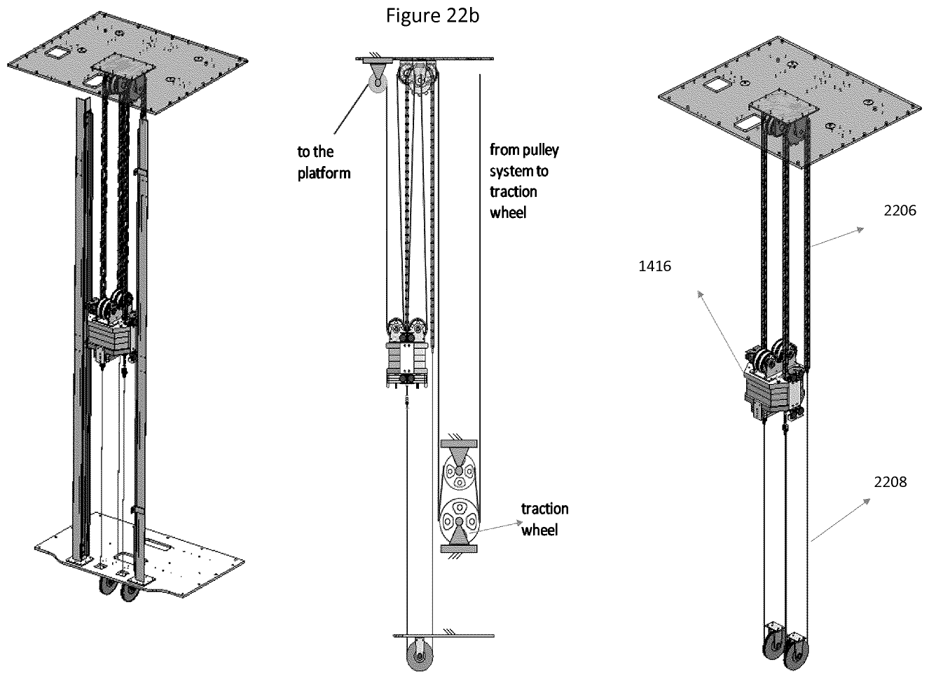

Turning to FIG. 22a, a schematic diagram of a counterbalancing system with linear/nonlinear effective load is shown. In the previous embodiments, the counterbalancing mechanisms provided a constant load that was used to counterbalance the weight of the platform. In the current embodiment, the counterbalancing system includes a variable load for use in reducing the size of the motors/actuators needed to move the platform. The system may be seen as a counterbalancing system with linearly variable effective load. FIG. 22b shows the cable path with respect to the counterweight system.

In the system of FIG. 22a, the linear/non-linear counterbalancing mechanism 2200 includes two cable loops 2202 and 2204, one cable loop 2202 is similar to the system disclosed in FIG. 14. The other cable loop 2204 includes two segments with different length densities. As will be understood, for ease of explanation and viewing, only the cable loop 2204 is shown. For cable loop 2204, one of the segments may be seen as a high density cable segment 2206 and the other segment may be seen as a low density segment 2208. In general, the second cable loop 2204 includes two cable segments having different densities.

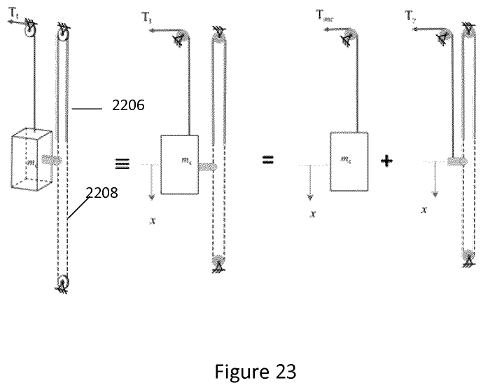

If the total applied tension of the linear/non-linear counterbalancing system 2200 is denoted by Tₜ as illustrated in FIG. 23, T₁=T_{cm}+T_{γ} where, T_{cm}=m_{c}g denotes the tension caused by the constant counterweight m_{c} and T_{γ} is the tension which is caused by the two-segment cable loop.

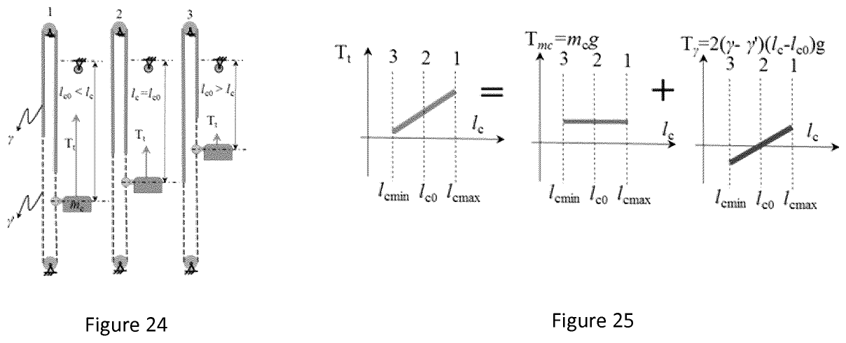

If the height of the constant counterweight is denoted by three different positions of the counterweight can be considered as illustrated in FIG. 24. In Example 2 of FIG. 24, a symmetric arrangement for the segments 2206 and 2208 of the cable loop is shown. In such configuration, I_{c} is denoted by I_{c0}. Denoting the length-density of cables segments by γ and γ′, we have T_{γ}=2(γ−γ′)(I_{c}−I_{c0})g. Based on the obtained T_{γ}, the schematic load variations of the system of FIG. 23 are illustrated in FIG. 25.

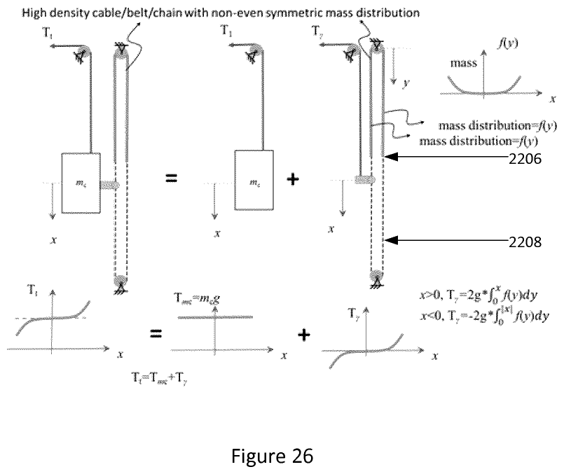

Similar to the system of FIG. 22a, a counterbalancing mechanism 2200 with nonlinear load effects is shown in FIG. 26. In this embodiment, mass distribution of the cable is considered as a nonlinear function ƒ(y) on both segments 2206 and 2208 of the second cable loop.

Denoting the height variation of m_{c} by x, T_{γ}=2g∫₀^{x} ƒ(y)dy for x≥0 and T_{γ}=−2g∫₀^{|x|}ƒ(y)dy for x<0. Obtaining T_{γ}, we have Tₜ=T_{cm}+T_{γ} as the total effective load of the current counterbalancing system 2200.

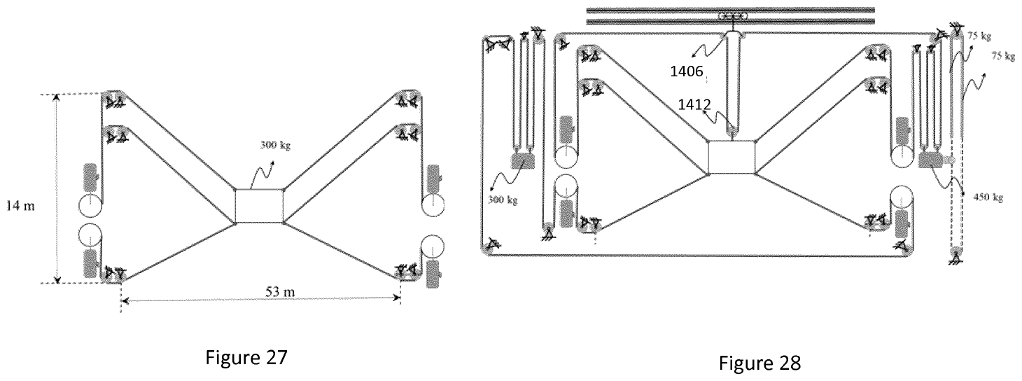

In order to more clearly describe the benefits and/or advantages of the current counterbalancing system or systems, a more detailed description of the size reduction of actuators is provided. FIG. 27 is a cable robot where four actuators and six cables are used to move a rectangular platform with 300 Kg mass in a 14 m×25 m vertical footprint workspace where no counterbalancing system is used. FIG. 28 is a cable robot system, in accordance with a specific embodiment of the disclosure, including at least one of the counterbalancing or counterweight system. In the counterbalancing/counterweight system of FIG. 28, a 450 Kg constant mass 1416 beside a two segment loop with the total mass difference 150 Kg are used on the top cable loop where a constant 300 Kg counterbalancing mass is used on the lower cable loop.

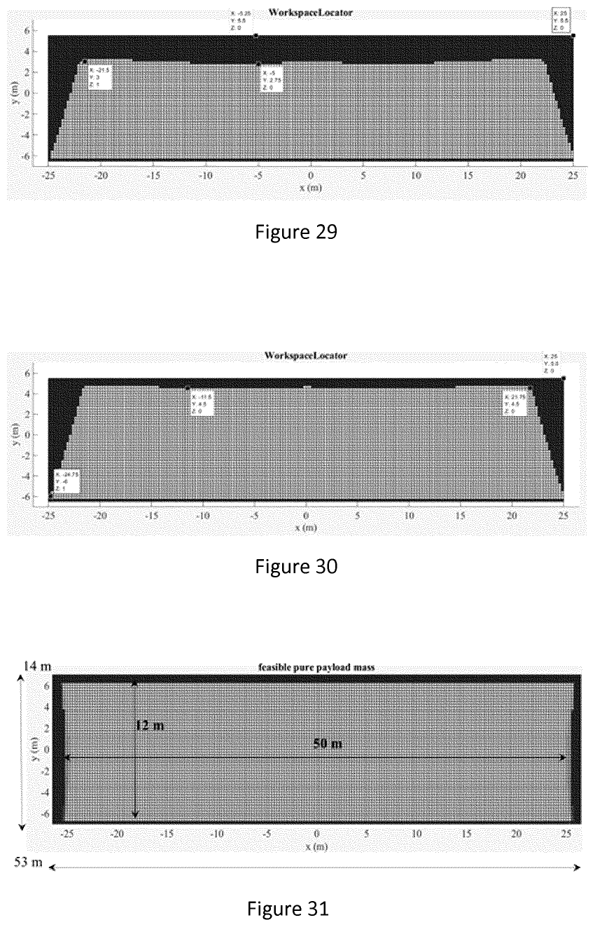

Workspace analysis of the cable robots of FIGS. 27 and 28 is provided in FIGS. 29 (FIG. 27), 30 (FIG. 28 with a maximum cable tension of 6 kN) and 31 (FIG. 28 with a maximum cable tension of 3 kN). It can be seen from FIGS. 29 to 31 that the reachable points of the robot footprint are denoted by the lighter shade/color. Comparison of the covered area shows that a system with a counterbalancing mechanism enables the cable robot to cover a larger workspace when it is using the maximum tension of 3 KN for each cable. Such load reduction allows the required size or the actuators in such systems to be reduced.

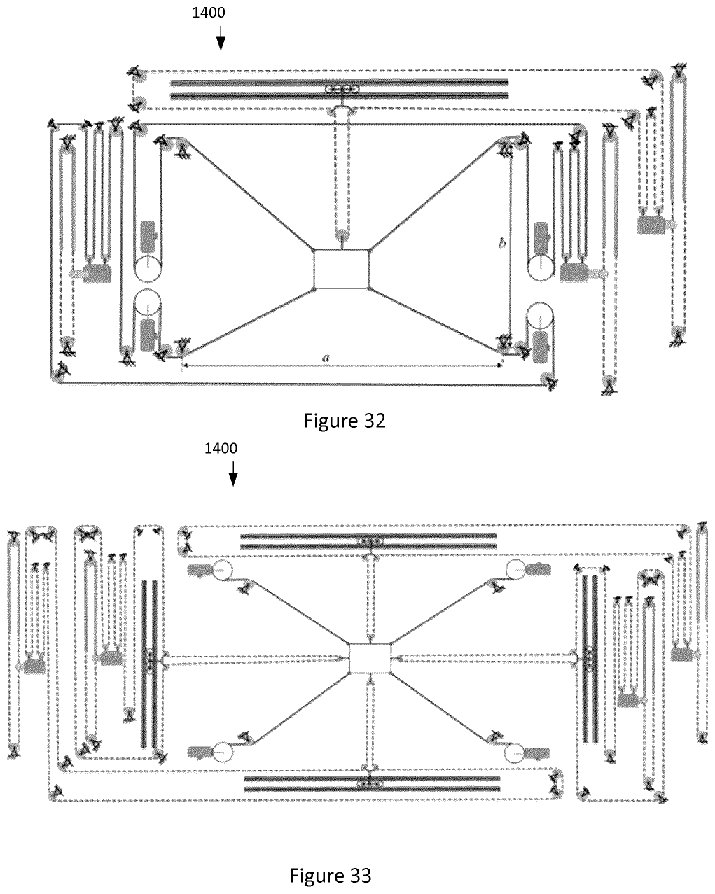

In a further embodiment, further combinations of a counterbalancing system and counterweight system are contemplated. For instance, based on experimental results, different combinations of a counterbalancing system and counterweight system may be used to enlarge the workspace of different cable robots. Two examples of such combinations are presented in FIGS. 32 and 33.

It will be understood that the combined counterbalancing and counterweight systems may also be used for 3D cable robots as well.

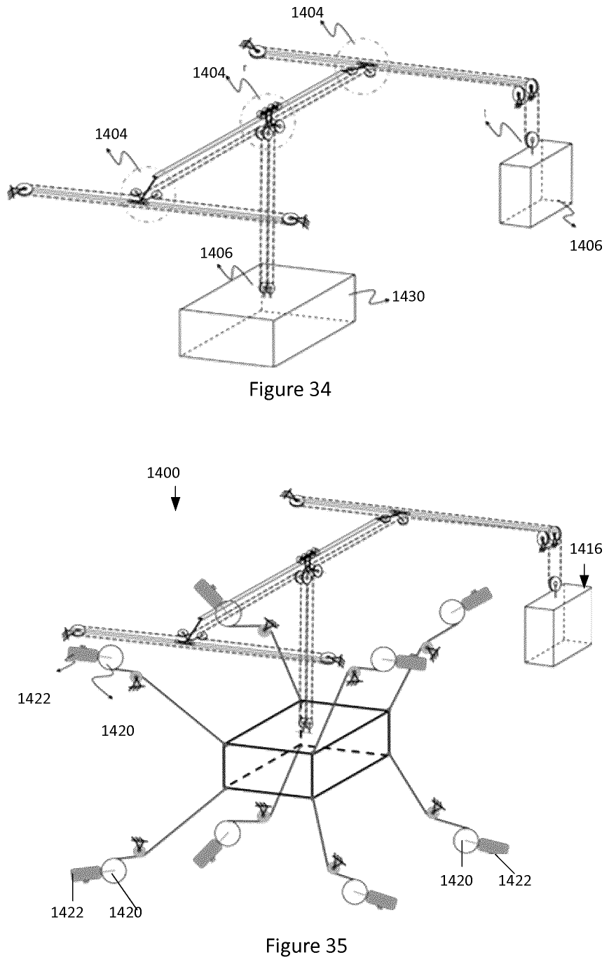

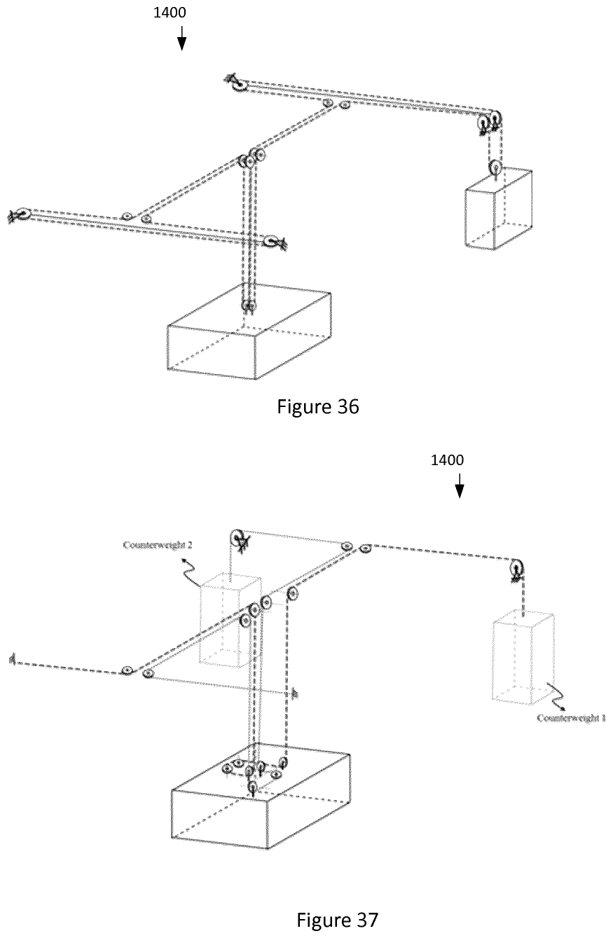

In the system of FIG. 34, the counterbalancing system (similar to the one disclosed in FIG. 14) is used to compensate the weight of the moving platform in a 3D cable robot. In the illustrated arrangement, the counterbalancing system includes three floating sliders to guide a counterbalancing cable-loop such that a vertical counterbalancing force is always applied on the moving platform. With respect to the number of floating pulleys, the magnitude of such force is preferably two-times the weight of illustrated counterweight. Each floating slider is preferably installed or mounted to a guiding rail where the guiding rail is floating all over the workspace. FIG. 35 shows the application of a counterbalancing system on a 3D cable robot. In order to simplify such illustrations in this document, as presented in FIG. 36 as an example, the guiding rails and floating sliders are not presented in the following Figures. Moreover, the actuators are only presented in cases where they are combined with the counterweight or counterbalancing systems.

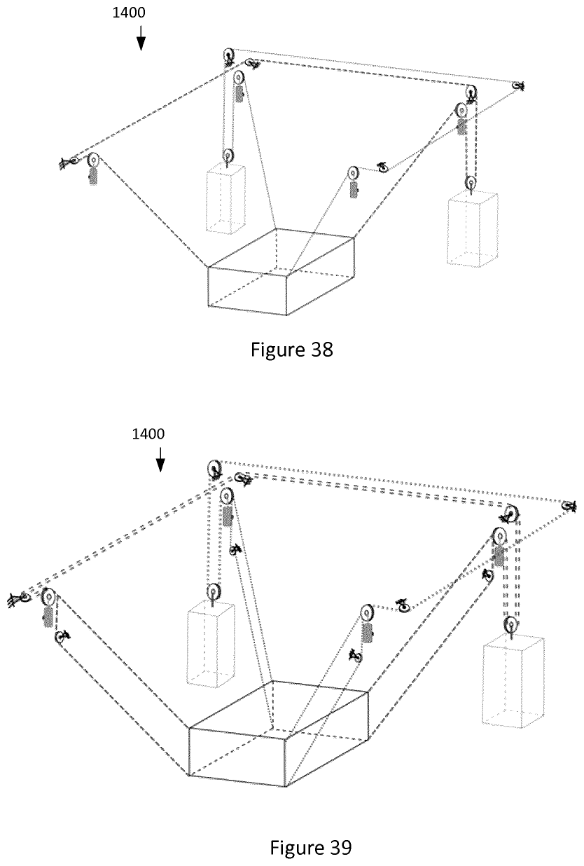

A further embodiment of a counterweight and/or counterbalancing system is shown in FIG. 37 where two counterweights are used to compensate for a weight of the moving platform. Application of traction wheels for actuation of cables in 3D cable robots is illustrated in FIG. 38 where two counterweights are used to reduce the load of actuators. FIG. 39 is a schematic diagram of a cable robot with constrained actuation with the counterbalancing/counterweight system of FIG. 38.

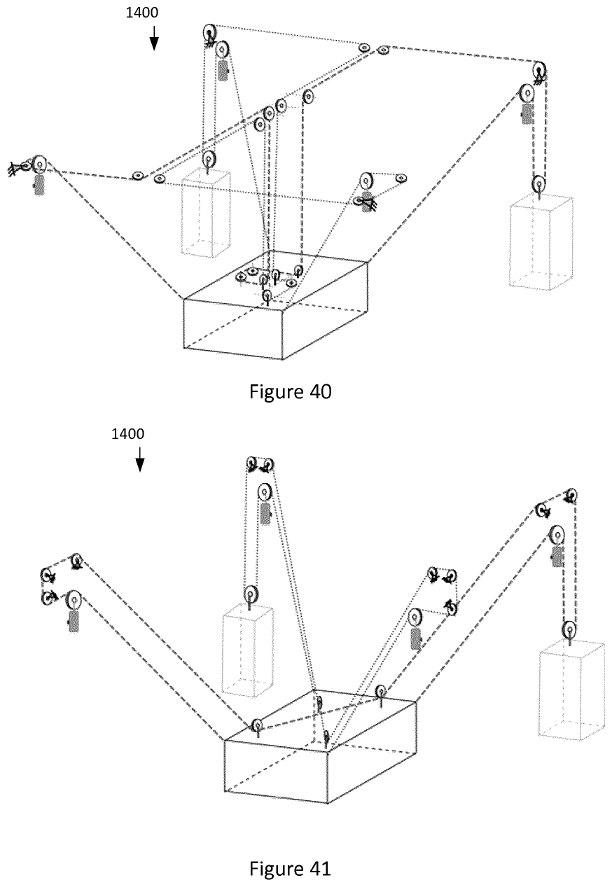

Combination of the counterbalancing system of FIG. 37 and cables actuation by traction wheel, presented in FIG. 38, is illustrated in FIG. 40, where the counterweight load is used for both counterbalancing the moving platform and torque reduction of actuators.

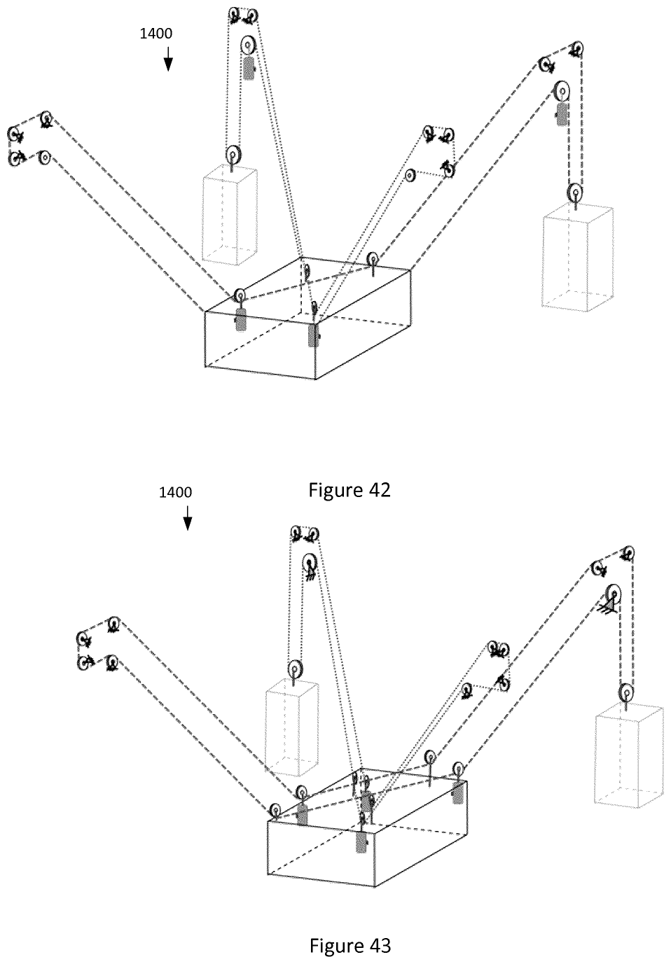

A further embodiment of a counterweight system is shown in FIG. 41. In the current embodiment, the arrangement of cables are used to use the counterweight to reduce the toque of motors and cancel the weight of moving platform. In such arrangement, no guiding rail or floating slider is needed whereby the structure of the cable robot is simplified. In the current embodiment, the traction wheels are preferably land-fixed. FIG. 42 and FIG. 43 are directed at the system of FIG. 41 where two (FIG. 42) or four (FIG. 43) traction wheels are installed on the moving platform. The arrangement of FIG. 43 makes it possible to have all of the actuator installation on the moving platform.

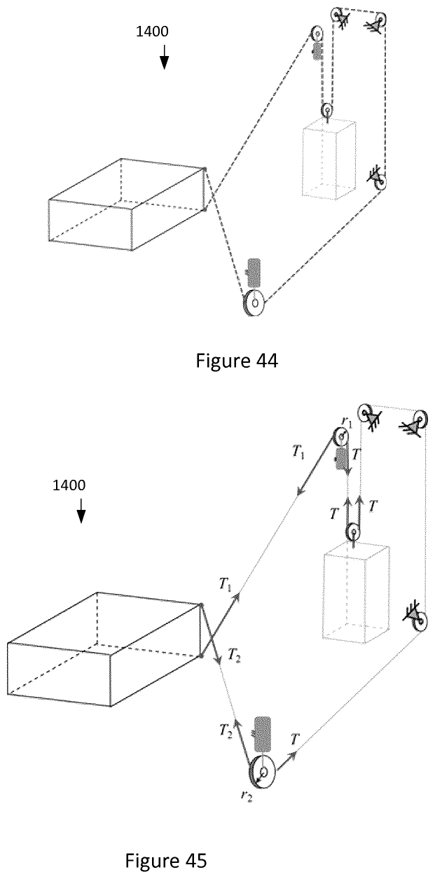

A different arrangement of the counterbalancing system is presented in FIG. 44 where a single cable loop is used on the top and bottom actuator of a single stand or tower. In this embodiment, components of each cable loop can be integrated or mounted to a single stand. Considering the tension distribution of the cables as illustrated in FIG. 45 (where the applied tension of counterbalancing system is denoted by T), to have a larger tension in the top cable rather than the bottom one T₁>T₂ when the size of both actuators on top and bottom are the same (M is the maximum torque of both actuators),

$$\frac{M}{{r}_{1}} + T > \frac{M}{{r}_{2}} + T$$

which concludes r₂>r₁. Accordingly, by selecting a larger size for traction wheel of the bottom actuator, a lager tension can be applied on the top cables. Such difference can be used to cancel the gravity effects which is applied on the top actuators only.

In order to improve the counterbalancing system, regular calibration of the system may be beneficial. One method of calibration is disclosed below.

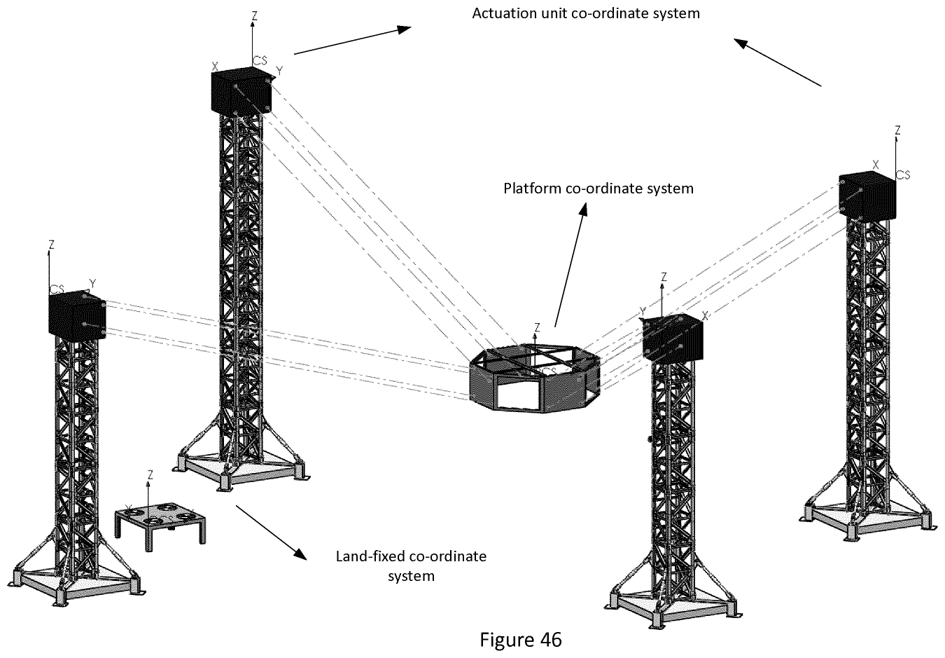

Based on the introduced constrained actuation method of the cables, rotational motions of the moving platform are reduced or eliminated. In such conditions, as illustrated in FIG. 46, if a coordinate system (CS) is attached or assigned to the moving platform and another one is fixed to the ground, the CS needs to be parallel all over the workspace. In order to enable the calibration system, geometrical requirements may be necessary.

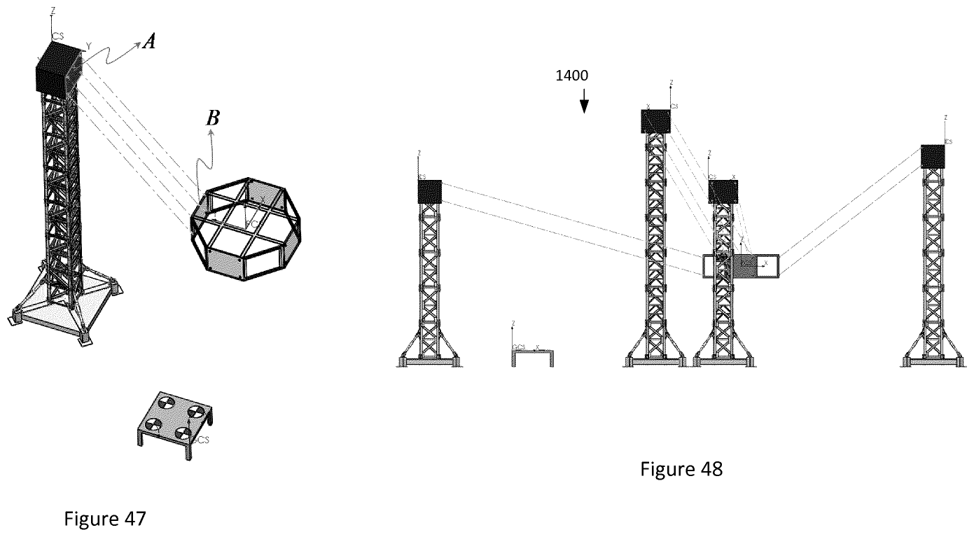

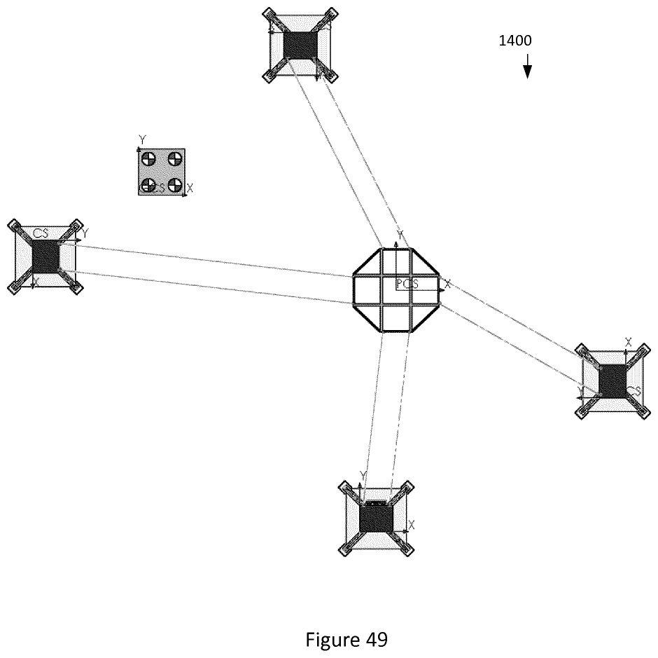

The necessary geometrical condition to keep the moving platform CS parallel with the land-fixed CS is to arrange the CDRUs to provide a pure translational motion for the moving platform. The only necessary condition to have such arrangement is to have parallelism between the corresponding planes of each set of cables as shown in FIG. 47. As this Figure shows, as long as the planes A and B, corresponding to the moving platform and actuation unit of each set of cables, are parallel, all the cables have the same lengths and moving platform has a pure translational motion. In order to cover the desire space of the workspace, the CDRUs may have different heights and locations as illustrated in FIG. 48 and FIG. 49 where such variation does not affect the necessary conditions to provide pure translational motion. Moreover, the orientation of bottom actuators are the same as the top CDRUs. Accordingly, in this section, the calibration of CDRUs is discussed only.

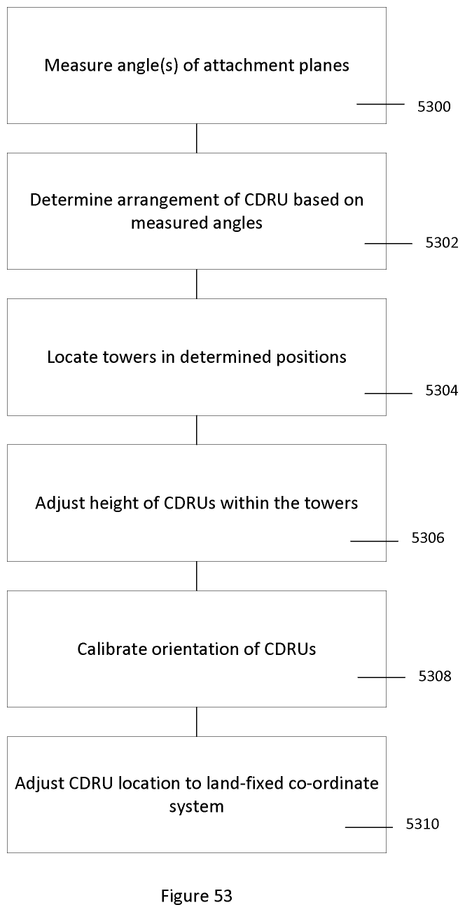

In a method of calibration, as mentioned, the location and height of CDRUs can be variable where their orientation needs to be calibrated. Moreover their height and position may need to be measurable to be used in the inverse kinematics of the robot. In order to adjust the orientation of the CDRUs' to keep their parallelism with their corresponding planes on the moving platform the following method may be performed. This is schematically shown in flowchart of FIG. 53.

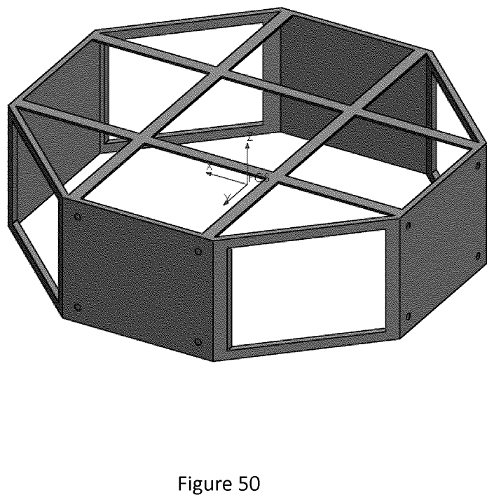

As shown in FIG. 53, firstly, an angle, or angles, of attachment planes on the moving platform are measured (5300) and the same angle or angles are considered for the arrangement of CDRUs (5302). As an example, in the illustrated moving platform of FIG. 50, the two attachment planes are perpendicular to each other. Then, the same angles are considered between the CDRUs.

The CDRU stands are then located in their desired position (5304) and the height of CDRUs to be adjusted (5306). After locating the CDRUs in their desired positon and heights, their orientation (5308) needs to be calibrated. In one embodiment, a land-fixed coordinate system is considered and the orientation of all CDRUs need adjusted according to the land-fixed co-ordinate system (5310).

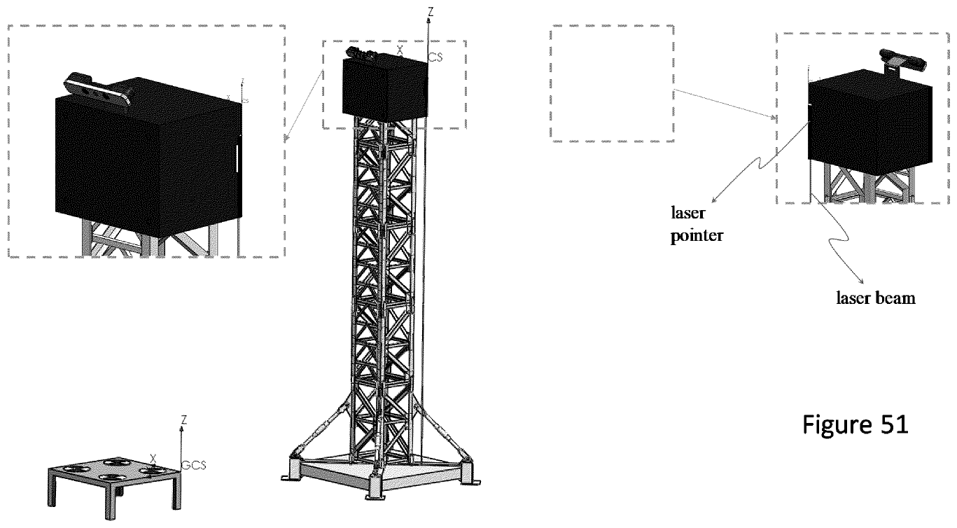

In order to find the orientation of CDRUs in a land-fixed CS, different standard approaches can be used. One of such approaches is presented in FIG. 51 (left), where an adjustment plate is fixed to the ground which has a coordinate system parallel to the coordinate system of the moving platform. On each CDRU, a camera is installed which is able to see and detect markers on the adjustment plate. Accordingly, the orientation of the CDRU can be adjusted. Using the same system, the exact position and height of each CDRU can be measured which is used in the inverse kinematics. Afterwards, the stands can be fixed in their exact position and orientation. In cases that variation of the CDRUs height is necessary, as shown in FIG. 51 (right), a laser measurement system can be used to find the updated height of them. Such system can be used to find the exact height of bottom actuators as well.

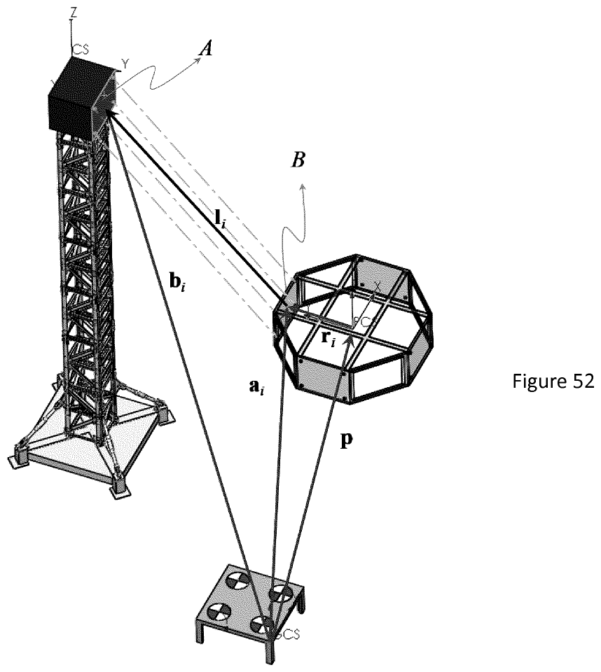

As illustrated in FIG. 52, based on the considered parallel arrangement of the moving platform planes with their corresponding CDRUs, all the cables of each CDRU have the same lengths. Finding the length of each set of cables for a desired position of the moving platform is the subject of inverse kinematics. Assuming a desired position p={x, y, z}^{T} for the moving platform center of mass in the land-fixed CS, lᵢ as the length of cable i corresponding to CDRUᵢ is obtained as

lᵢ=∥lᵢ∥=∥bᵢ−aᵢ∥

where bᵢ is measured in the calibration steps and

aᵢ=p+rᵢ

where, based on the dimensions of the moving platform, rᵢ is measurable.

Finding lᵢs for all cables, the position command of the actuation units are provided. It is worth to mention that in order to keep all cables under tension, the bottom actuators can apply different value of tensions which can be optimized to improve the stiffness of the moving platform all over the workspace.

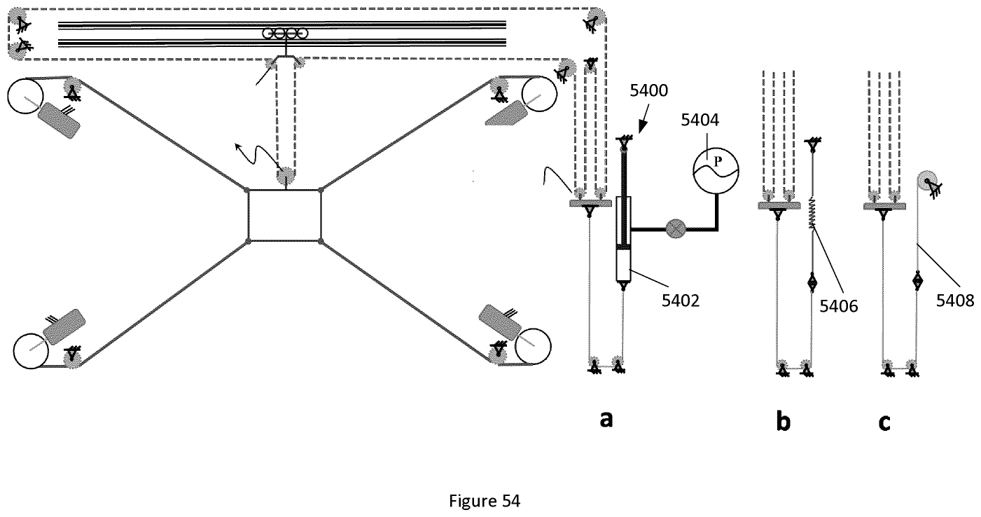

Turning to FIG. 54, further embodiments of a system for a robotic platform is shown. The current embodiment is similar to the counterbalancing system of FIG. 14. The difference between the system of FIG. 14 and the system of 54 relates to the type of counterbalancing being used. In FIG. 14, the counterbalance or counterweight 1416 is replaced with a different type of counterbalance.

The embodiments of FIG. 54 provide further embodiments to providing a counterbalance to balance the gravity force on the moving platform and the lower cable tensions during operation. FIG. 54a may be seen as an air spring counterbalance configuration, FIG. 54b may be seen as a spring counterbalance configuration and FIG. 54c may be seen as a constant spring counterbalance configuration.

With FIG. 54a, the air spring 5400 may be an air over hydraulic spring in which a hydraulic cylinder 5402 is connected to an accumulator 5404, such as a bladder type accumulator, with pressure P. The pressure P and the size of accumulator 5404 is adjusted based on the counter-force needed to counterbalance the force on or the location of the moving platform and also the travel of the hydraulic cylinder 5402. These parameters may be determined by a controller or CPU 114. In a preferred embodiment, the pulley arrangement between the floating pulleys and the hydraulic cylinder 5402 can be arranged to change the combination of cylinder stroke and pressure P. It is also possible to adjust the pressure P as a function of the platform location to provide more effective counter-force through a controlled valve if needed.

With the embodiments of FIGS. 54b and 54c, a linear spring 5406 or constant force spring 5408 are used, respectively, to provide the counter-force. Although not shown, a combination of the counterbalances in FIGS. 8a and 54a to 54c may be used to provide the counter-force or counterbalance to reduce the load on the motors.

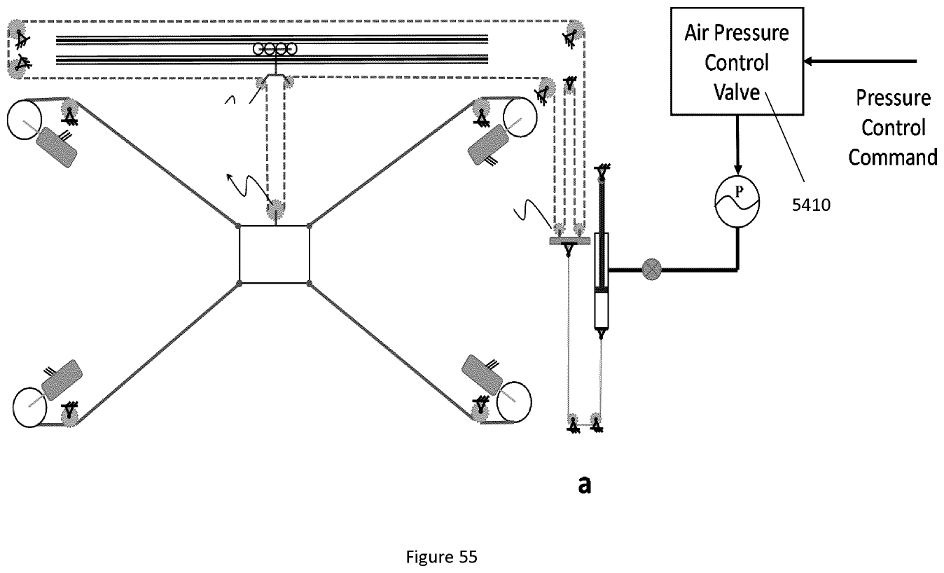

Turning to FIG. 55, another embodiment of a counterbalancing system is shown. The embodiment of FIG. 55 is similar to the embodiment of FIG. 54a but further includes an air pressure controller, such as an air pressure control valve, 5410 that can be used to adjust the pressure P as a function of the platform location, mass, or other factors. In this manner, the controller may be used to provide more effective counter-force for the movement of the platform.

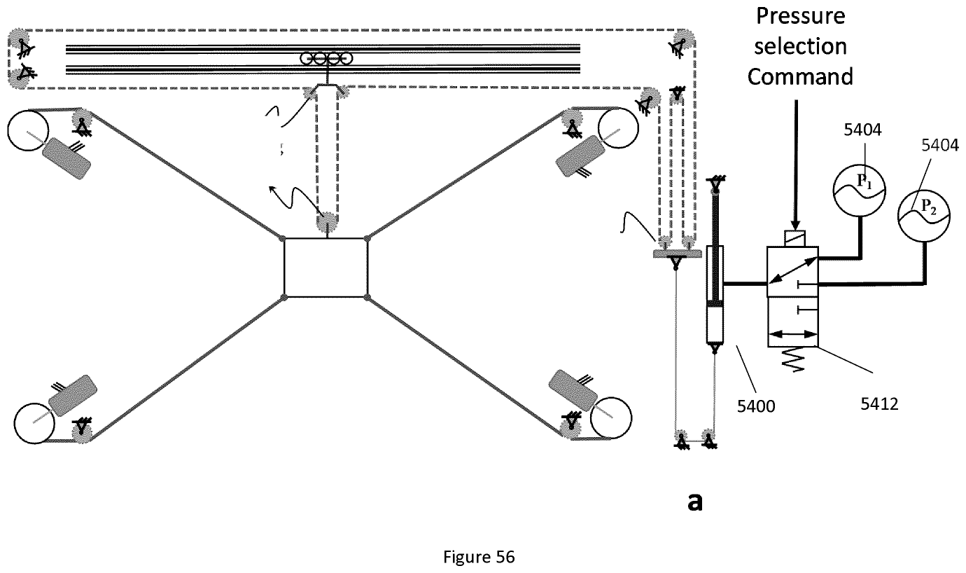

Turning to FIG. 56, another embodiment of a counterbalancing system is shown. The embodiment of FIG. 56 includes a set of accumulators with different pressure settings to adjust the counter-force of the air spring 5400. In this embodiment, at any time, only one of the accumulators is connected to the cylinder 5400 through for example a solenoid driven directional valve 5412. The selection command is provided through a controller considering the platform location, mass, or other factors. This may be controlled by a central processing unit that determines an adequate pressure based on inputs from sensors associated with the platform, these sensors transmitting information associated with, but not limited to, platform location, mass, or other factors.

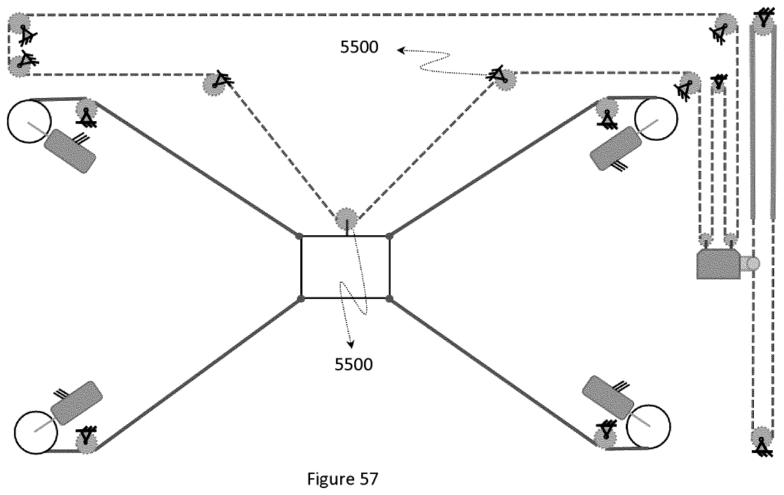

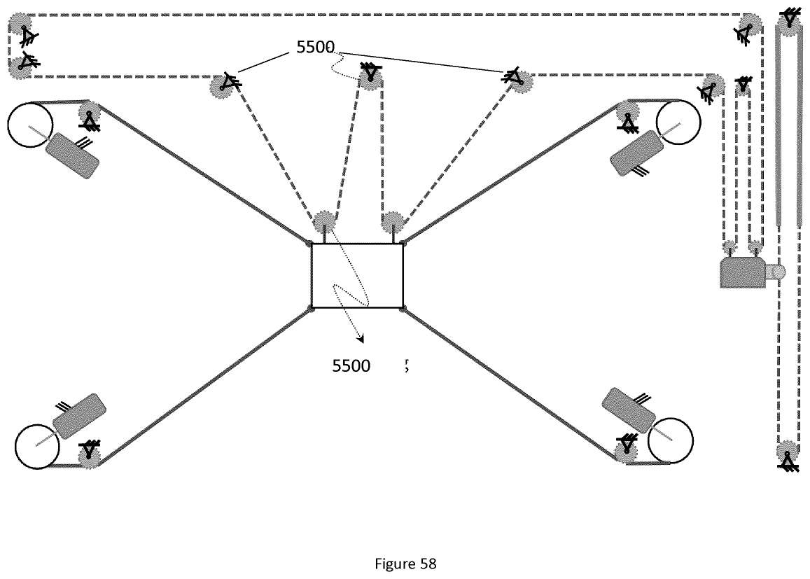

Turning to FIGS. 57 and 58, further embodiments of a counterweight system are shown. Unlike the systems disclosed above with respect to FIG. 14, the moving trolley is replaced with a pulley system. In FIG. 57, the moving trolley may be replaced by a set of fixed pulleys 5500. The embodiment of FIG. 57 uses the same arrangements for applying a counterforce to the platform weight and lower cables tensions using a counter mass, or spring. In the embodiment shown in FIG. 57, only two fixed pulleys are used while the number of such pulleys can be increased as shown in FIG. 58 to make this embodiment as effective as the moving trolley but with a pulley system.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

What is claimed is:

1. A system for a robotic platform for use in large workspaces comprising:
a moving platform;
a set of cable controlling units;
a set of cables connected between the moving platform and the set of cable controlling units; and
at least one counterbalancing or counterweight system for managing unwanted forces being experienced by the moving platform, the at least one counterbalancing or counterweight system attached to the moving platform and integrated with at least some of the set of cables.

2. The system of claim 1 wherein the at least one counterbalancing or counterweight system is a counterbalancing system.

3. The system of claim 2 wherein the counterbalancing system comprises:
a guide connected to the moving platform;
a set of pulleys;
a counterbalancing apparatus; and
a closed cable loop passing through the set of pulleys and the guide and connected to the counterbalancing apparatus;
wherein the counterbalancing apparatus provides a counterforce to gravity acting on the moving platform.

4. The system of claim 3 wherein the counterbalancing apparatus comprises at least one of a counterbalancing weight, an air spring, a normal spring or a constant spring.

5. The system of claim 2 wherein the counterbalancing system further comprises:
a guide rail; and
a moving pulley that slides up and down the guide rail wherein the moving pulley is one of the set of pulleys;
wherein movement of the moving pulley with respect to the moving platform provides a counterbalancing force to the moving platform.

6. The system of claim 4 wherein the counterbalancing apparatus comprises an air spring.

7. The system of claim 6 wherein the counterbalancing apparatus further comprises a hydraulic cylinder and an accumulator.

8. The system of claim 1 wherein the at least one counterbalancing or counterweight system is a counterweight system.

9. The system of claim 8 wherein the counterweight system comprises:
a counterweight apparatus; and
a closed cable loop passing through two adjacent cable controlling units and the counterweight apparatus and connected to two corners of the moving platform.

10. The system of claim 9 wherein the counterweight apparatus comprises:
a set of pulleys; and
a counterweight;
wherein at least some of the set of pulleys are associated receive the closed cable loop and are indirectly connected to the counterweight.

11. The system of claim 10 wherein the counterweight is a cable having at least two different density segments.

12. The system of claim 1 further comprising a controller for controlling the cable controlling units and the at least one counterbalancing or counterweight system.

13. The system of claim 1 further comprising a set of towers defining the large workspace, the set of towers for housing one of the set of cable controlling units.

14. The system of claim 13 wherein the number of towers in the set of towers equals the number of cable controlling units in the set of cable controlling units.

15. The system of claim 1 wherein each of the set of cable controlling units comprises a top actuator unit.

16. The system of claim 15 wherein each of the set of cable controlling units comprises a bottom actuator unit.
